(19) United States
(12) Patent Application Publication
(10) Pub. No.: US 2008/0289964 A1
(43) Pub. Date: Nov. 27, 2008

(54) Assays for diagnosis and therapeutics employing similarities and differences in blood serum concentrations of 3 forms of complement C3c and related protein biomarkers between amyotrophic lateral sclerosis and Parkinson's disease

(76) Inventors: Ira Leonard Goldknopf, The Woodlands, TX (US); Essam Ahmed Sheta, The Woodlands (EG); Stanley H. Appel, Houston, TX (US)

Correspondence Address: Power3 Medical Products, Inc., 3400 Research Forest Drive, The Woodlands, TX, 77381, US

(21) Appl. No.: 11/507,337

(22) Filed: Aug. 21, 2006

Related U.S. Application Data
(60) Provisional application No. 60/710,818, filed on Aug. 24, 2005.
(60) Provisional application No. 60/742,462, filed on Dec. 5, 2005.
(60) Provisional application No. 60/752,129, filed on Dec. 20, 2005.

(51) Int. Cl. G01N 27/26

(52) U.S. Cl. 204/461

(57) ABSTRACT

The invention relates to assays for diagnosis, drug targeting and therapeutic response monitoring, of patients with Parkinson's disease (PD), with PD-Like disorders that express symptoms like PD, age-matched controls (Normal), Patients with Amyotrophic Lateral Sclerosis (ALS), with ALS-Like disorders that express symptoms like ALS, and age-matched controls (Normal). The method is based on the use of 2-dimensional (2D) gel electrophoresis to separate the complex mixture of proteins found in blood serum, the quantitation of a group of identified biomarkers, and the biostatistical analysis of the concentration of the identified biomarkers.

### CROSS REFERENCE TO RELATED APPLICATIONS

This application claims priority to U.S. Provisional patent application Ser. No. 60/710,818 filed on Aug. 24, 2005 and entitled “Complement C3c and Related Protein Biomarkers in ALS, Parkinson's Disease, and their Like Disorders” by inventors Ira L. Goldknopf, et al. It also claims priority to U.S. Provisional patent application 60/742,462 filed on Dec. 12, 2005 and entitled “Remarkable Similarities and Differences in Serum Concentrations of 3 forms of Complement C3 and Related Protein Biomarkers among ALS, Parkinson's and “Like” Diseases—C3 and Related Biomarkers and Diagnosis” by inventors Ira L. Goldknopf, et al. It also claims priority to U.S. Provisional patent application 60/752,129 filed on Dec. 21, 2005 and entitled “2D Gel Blood Serum Biomarkers and Testes for Differential Diagnosis, Disease Burden and Drug Response Monitoring, and Drug Targeting for the Neurodegenerative Diseases” by inventors Ira L. Goldknopf, et al.

### BACKGROUND OF THE INVENTION

1. Field of the Invention

The invention relates to a characteristic pattern of Complement C3 and related proteins that can be used in diagnosis, drug targeting, and therapeutic response monitoring of patients having Amyotrophic Lateral Sclerosis (ALS), patients with Parkinson's disease (PD), patients with ALS-like and PD-Like disorders, that express symptoms similar to ALS and/or PD, and normal age-matched individuals. The method is based on the use of 2-dimensional (2D) gel electrophoresis to separate the complex mixture of proteins found in blood serum and the quantitation of a functionally related group of identified biomarkers, 3 forms of complement C3c and related biomarkers, to differentiate patients having ALS or PD patients from each other and from patients with ALS-like and PD-Like disorders, and from normal individuals, for the purpose of diagnosis, and for determination of disease burden, treatment response monitoring, and drug targeting.

2. Description of the Related Art

There is an urgent need for diagnostic tests for Lou Gehrig's disease (ALS), Parkinson's disease (PD), and “like” disorders. ALS is characterized by degeneration of both upper and lower motor neurons. The majority of patients die within 3-5 years from first symptom [1], usually from respiratory muscle failure. Most of the ALS cases occur in unrelated individuals, i.e. sporadic ALS (sALS). Inheritance is observed in about 10% of cases, i.e. familial ALS (fALS) [2]. In 10-20% of fALS cases, a mutation can be identified in the gene for superoxide dismutase 1 (SOD1), a ubiquitously expressed antioxidant protein [3-5] and this accounts for less than 2% of all ALS cases. Clearly, genetic testing is not applicable to the majority of ALS cases. In fact, from a clinical standpoint, patients with fALS and sALS are indistinguishable [6-9]. Presently, the diagnosis of ALS is symptom based and a definitive diagnostic test is not currently available. The usual diagnostic process consists of a full medical history and a comprehensive physical and neurological examination according to the El Escorial ALS diagnostic criteria [10, 11]. A complete evaluation may include an electromyogram (EMG) with nerve conduction studies (NCV), magnetic resonance imaging (of the brain and spinal cord, lumbar puncture (LP) with analysis of cerebrospinal fluid (CSF), a panel of blood tests, and muscle biopsy. Because the El Escorial criteria set was originally designed for research purposes, many clinicians find it to be somewhat cumbersome [10]. Researchers have searched for genetic susceptibility factors affecting cellular processes that influence the survival of motor neurons, including excitotoxicity [12, 13], oxidative stress [14], neurofilament abnormalities [15, 16], inflammation, immune-inflammation, growth factors, axonal transport, and other processes [17-19]. However, to date, no susceptibility factor has emerged to account for the majority of ALS cases.

PD results primarily from the death of dopaminergic neurons in the substantia nigra. The loss of dopamine production from these cells results in the primary symptoms of PD [20]. Although the PD conditions usually affect those above age 65, 15% of those diagnosed are under age of 50. Studies indicate that physicians make an incorrect initial diagnosis of PD in 24% to 35% of cases [21]. Even general neurologists have difficulties in correctly identifying the disease [22, 23]. The diagnosis is based on a thorough physical and neurological examination. Blood tests and imaging studies (MRI of brain) are performed to rule out other conditions that have similar symptoms. There is currently no blood test or imaging study that can confirm the diagnosis of PD. The disease is treatable, but not curable [23]. Ongoing studies are attempting to identify ways of slowing the deterioration of the dopamine-producing cells [24, 25]. However, the symptoms of PD do not appear until about 80% of the dopamine-producing cells are already dead or impaired [26].

Proteomics is a new field of medical research wherein proteins are identified and linked to biological functions, including roles in a variety of disease states. With the completion of the mapping of the human genome, the identification of unique gene products, or proteins, has increased exponentially. In addition, molecular diagnostic testing for the presence of proteins already known to be involved in certain biological functions has progressed from research applications alone to use in disease screening and diagnosis for clinicians. However, proteomic testing for diagnostic purposes remains in its infancy. There is, however, a great deal of interest in using proteomics for the elucidation of potential disease biomarkers.

Detection of abnormalities in the genome of an individual can reveal the risk or potential risk for individuals to develop a disease. The transition from gene based risk to emergence of disease can be characterized as an expression of genomic abnormalities in the proteome. In fact, whether arising from genetic, environmental, or other factors, the appearance of abnormalities in the proteome signals the beginning of the process of cascading effects that can result in the deterioration of the health of the patient. Therefore, detection of proteomic abnormalities at an early stage is desired in order to allow for detection of disease processes either before the disease is established or in its earliest stages where treatment may be more effective.

Recent progress using a novel form of mass spectrometry called surface enhanced laser desorption and ionization time of flight (SELDI-TOF) for the testing of ovarian cancer and Alzheimer's disease has led to an increased interest in proteomics as a diagnostic tool [27, 28]. Furthermore, proteomics has been applied to the study of breast cancer through use of 2D gel electrophoresis and image analysis to study the development and progression of breast carcinoma in patients' breast ductal fluid specimens and in plasma from Alzheimer's disease patients [29, 30]. In the case of breast cancer, breast ductal fluid specimens were used to identify distinct protein expression patterns in bilateral matched pair ductal fluid samples of women with unilateral invasive breast carcinoma.

Detection of biomarkers is an active field of research. For example, U.S. Pat. No. 5,958,785 discloses a biomarker for detecting long-term or chronic alcohol consumption. The biomarker disclosed is a single biomarker and is identified as an alcohol-specific ethanol glycoconjugate. U.S. Pat. No. 6,124,108 discloses a biomarker for mustard chemical injury. The biomarker is a specific protein band detected through gel electrophoresis and the patent describes use of the biomarker to raise protective antibodies or in a kit to identify the presence or absence of the biomarker in individuals who may have been exposed to mustard poisoning. U.S. Pat. No. 6,326,209 B1 discloses measurement of total urinary 17 ketosteroid-sulfates as biomarkers of biological age. U.S. Pat. No. 6,693,177 B1 discloses a process for preparation of a single biomarker specific for O-acetylated sialic acid and useful for diagnosis and outcome monitoring in patients with lymphoblastic leukemia.

Two-dimensional (2D) gel electrophoresis has been used in research laboratories for biomarker discovery since the 1970's [31-38]. Recently, faster identification of proteins by in-gel digestion and mass spectrometry has provided large-scale application of these techniques [39, 40], while the advent of bioinformatics is progressing proteomics towards diagnostics [41-43]. Comprehensive analyses of disease mechanisms and disease markers is now feasible through clinical proteomics [44].

Neurodegenerative diseases are among those devastating disorders for which the need for early diagnosis is most pressing. These include amyotrophic lateral sclerosis (ALS), Parkinson's disease (PD), Alzheimer's disease (AD), and many other neurological disorders. These central nervous system disorders are characterized by the progressive loss of neural and related tissues. Clearly, earlier identification of those with PD, ALS, and like disorders may help to optimize the management of these patients. The present invention involves demonstrated differences in the expression of Complement C3 and related proteins from 422 patients and normal individuals. The biochemical and mechanistic implications of these results, as well as their use combined with biostatistics, are also disclosed.

### SUMMARY OF THE INVENTION

The present invention is a diagnostic assay for differentiating between patient's having Amyotrophic Lateral Sclerosis (ALS), Parkinson's disease (PD), ALS-Like and/or PD-Like disorders, and normal controls. The method comprises collecting a biological sample from a patient having symptoms consistent with ALS and/or PD, determining the concentrations of up to 34 protein biomarkers identified as related to ALS, PD, ALS-Like, or PD-like disorders, and determining whether or not the patient has ALS, PD, or an ALS-Like, or PD-like disorder, based on a statistical analysis of the concentration in blood serum of the selected 34 protein biomarkers including the Complement C3c and related protein biomarkers.

One aspect of the present invention is a method for screening a patient for ALS, PD, ALS-Like, or PD-like disorders. The method includes: collecting a biological sample from a patient having symptoms consistent with ALS or PD, determining the concentrations of up to 34 protein biomarkers identified as related to ALS, PD, ALS-Like, or PD-like disorders, and determining whether or not the patient may have ALS, PD, or an ALS-Like, or PD-like disorder, based on a statistical analysis of the concentration in blood serum of the selected 34 protein biomarkers including the Complement C3c and related protein biomarkers. Another aspect of the present invention is a method for determining the burden of disease and/or monitoring the response to treatment of a patient with ALS, PD, ALS-Like, or PD-like disorders. The method includes: collecting a biological sample from a patient having symptoms consistent with ALS and/or PD, determining the concentration of up to 34 protein biomarkers identified as related to ALS, PD, ALS-Like, or PD-like disorders, and determining the burden of disease and/or response of the patient to treatment based on the concentration in blood serum of the selected 34 protein biomarkers including the Complement C3c and related protein biomarkers.

Another aspect of the present invention is a method for determining the biological mechanism of disease of a patient and/or the drug target of the patient for treatment of ALS, PD, ALS-Like, or PD-like disorders. The method includes: collecting a biological sample from a patient having symptoms consistent with ALS or PD, determining the concentration of up to 34 protein biomarkers identified as related to ALS, PD, ALS-Like, or PD-like disorders, and determining the mechanism of disease active in the patient and/or the drug target appropriate for treatment of the patient, based on the concentration in blood serum of the selected 34 protein biomarkers including the Complement C3c and related protein biomarkers.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the methods for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1: a representative 2D gel electrophoretic image of human serum proteins with 34 biomarkers marked by arrows and Complement C3 and related biomarkers numbered.

FIG. 2: Amino acid sequence spanned by tryptic peptides identified in-gel trypsin digestion, MaldiTOF MS, and by LC-MS/MS of spots 7310, 9311, and 9312, the C3c biomarkers, where 7310 and 9311 have the same amino acid sequence derived from the C3c domain of C3 parent, and C3 biomarker 9312 is identical to 9311 in sequence and very close in pI, but is missing a short peptide at the C-terminal, consistent with its slightly lower molecular weight, and where all three sequences span the glycosylation site, asparagine-939.

FIG. 3: The parent Complement C3 and Similar to C3 molecules, a) position of amino acid sequence domains C3c, similar to C3c, and C3dg in the overall structures with processing sites, b) tryptic peptides in the digests that exclude similar to C3c as a possible identity for 7310, 9311, or 9312 and c) the Complement C3 processing steps and the C3 related protein biomarkers involved in the processing.

FIG. 4: Enlarged section of 2D gel biomarker spots 7310, 9311 and 9312. Gels are stained with (a) SyproRuby™ protein stain, (b) Pro-Q Diamond Phosphoprotein stain, (c) Pro-Q Diamond™ Phosphoprotein stain followed by SyproRuby™ protein stain and (d) Pro-Q Emerald™-488 glycoprotein stain, indicate that only 7310 is phosphorylated, while all 3 are glycosylated (e), and confirmation of the C3c identity using Western immunoassay with sheep anti-C3c polyclonal antibody (Abcam).

FIG. 5: Post-synthetic modifications of C3c biomarkers and disease specific changes in serum concentrations.

FIG. 6: Disease specific pathway differences implied by the differences in levels of the Complement C3 and related biomarkers in the serum of sporadic ALS, familial ALS, and Parkinson's disease patients. Differentially expressed serum biomarker levels measured by the method are shown, including normal, above normal, and below normal serum levels.

FIG. 7: Thirteen (13) PD optimal biomarkers and their relative mean serum concentrations between the various diseases and controls.

FIG. 8: Two examples of individual biomarker statistics: Box and Whisker profiles, mean profiles, and summary statistics, of selected biomarkers used to discriminate among ALS, PD, AD, ALS-Like, PD-Like, AD-Like and Normal controls, a) Haptoglobin Like, a biomarker elevated in concentration in PD, b) Apo lipoprotein E3, a biomarker reduced in concentration in PD.

FIG. 9: Mechanism of neurodegeneration in ALS patients measurable in blood serum indicated by disease specific changes in selected biomarkers.

FIG. 10: Mechanism of neurodegeneration in PD patients measurable in blood serum indicated by disease specific changes in selected biomarkers.

Table 1: List of Complement C3 and related biomarkers identified by MaldiTOF and LC MS/MS of in-gel tryptic peptide digests, and characterized by 2D gel electrophoresis of the intact proteins.

Table 2: Alternative names and amino acid sequence of the parent Complement C3 full-length transcript, and its processing components with positions of the amino acid sequence of biomarkers C3c=spots 7311, 9311, 9312, and C3dg=spot 1511.

Table 3: cDNA sequence of full length parent Complement C3 indicating the beginning and end of coding regions of C3c and C3dg.

Table 4: Amino acid sequence of Similar to Complement C3, including its identical C3dg domain and its non-identical C3c like region.

Table 5: Shows the amino acid sequence identity in the C3dg domain between Complement C3 and Similar to C3.

Table 6: Comparison of serum levels of biomarkers of Complement C3c, Complement C3 related proteins: Factors H and Bb, and Pre-serum Amyloid Protein (SAP), between Normal individuals and patients with ALS, Parkinson's disease, and like disorders, with both averages and Single Variable Linear Discriminant Biostatistics shown.

Table 7: Linear discriminant biostatistical analysis of the 13 PD optimal biomarkers, PD vs. age-matched normal controls.

Table 8: Validation of blood serum biomarkers and test for PD vs. PD-Like and normal controls. Training and independent test sets.

Table 9: Validation of blood serum biomarkers and test for ALS vs. ALS-Like and normal controls. Training and independent test sets.

### DESCRIPTION OF THE PREFERRED EMBODIMENTS

The present invention is a diagnostic assay for differentiating between patients having Amyotrophic Lateral Sclerosis (ALS), Parkinson's disease (PD), ALS-Like and/or PD-Like disorders, and normal controls. The method is based on the use of 2-dimensional (2D) gel electrophoresis to separate the complex mixture of proteins found in blood serum and the quantitation of a group of identified biomarkers to differentiate between patients having ALS, PD, ALS-Like and/or PD-Like disorders, and normal controls.

In the context of the present invention an “ALS-Like disorder or a PD-Like disorder” would include individuals with symptoms consistent with ALS or PD, including without limitation, for ALS, muscle weakness, numbness, slurred speech, and for PD, slowness of movements, muscle stiffness, tremor, rigidity, slow stooped gait, and difficulty with balance.

The ALS like conditions, are divided into 6 main anatomical categories, as follows:

### 1. Cervical Spinal Compromise (Myelopathy)

a. Cervical Disc Protrusion

b. Spinal Stenosis

c. Spinal Cord Tumor

d. Primary lateral sclerosis

### 2. Multiple Sclerosis

### 3. Lower Motor Neuron Compromise

a. Post Polio Syndrome

b. Spinal Muscular Atrophy

### 4. Nerve Disease

a. Guillain Barre Syndrome

b. Chronic Inflammatory Demyelinating Polyreuropathy (CIDP)

c. Other Causes of Motor Neuron Compromise
i. Multifocal motor neuropathy

### 5. Neuromuscular Junction Compromise

a. Myasthenia Gravis

b. Myasthenia Syndrome (LEMS)

c. Toxins (Black Widow Spider)

### 6. Muscle Disease

a. Muscular Dystrophy

b. Inclusion Body Myositis (IBM)

c. Polymyositis

The PD-like disorders include movement disorders other than PD, including but not limited to:

### 1. Ataxia

### 2. Atypical Paridnsonism

### 3. Cortical-Basal Ganglionic Degeneration

4. Dementia with Lewy Bodies

### 5. Dystonia

### 6. Essential Tremor

### 7. Multiple System Atrophy

### 8. Progressive Supranuclear Palsy

### 9. Vascular (CVA or Multi-infarct) Parkinsonism

10. Also included is Alzheimer's disease (AD), particularly in the early stages.

In the context of the present invention, the “protein expression profile” corresponds to the steady state level of the various proteins in biological samples that can be expressed quantitatively. These steady state levels are the result of the combination of all the factors that control protein concentration in a biological sample. These factors include but are not limited to: the rates of transcription of the genes encoding the hnRNAs; processing of the hnRNAs into mRNAs; The rates of splicing and the splicing variations during the processing of the hnRNAs into mRNAs which govern the relative amounts of the protein sequence isoforms; the rates of processing of the various mRNAs by 3′-polyadenylation and 5′-capping; the rates of transport of the mRNAs to the sites of protein synthesis; the rate of translation of the mRNA's into the corresponding proteins; the rates of protein post-translational modifications, including but not limited to phosphorylation, nitrosylation, methylation, acetylation, glycosylation, poly-ADP-ribosylation, ubiquitinylation, and conjugation with ubiquitin Like proteins; the rates of protein turnover via the ubiquitin-proteosome system and via proteolytic processing of the parent protein into various active and inactive subcomponents; the rates of intracellular transport of the proteins among compartments, such as but not limited to the nucleus, the lysosomes, golgi, the membrane, and the mitochondrion; the rates of secretion of the proteins into the interstitial space; the rates of secretion related protein processing; and the stability and rates of proteolytic processing and degradation of the proteins in the biological sample before and after the sample is taken from the patient.

In the context of the present invention, a “biomarker” corresponds to a protein or protein fragment present in a biological sample from a patient, wherein the quantity of the biomarker in the biological sample provides information about whether the patient exhibits an altered biological state such as ALS, PD or an ALS-Like or a PD-Like disorder.

A “control’ or “normal” sample is a sample, preferably a serum sample, taken from an individual with no known disease, particularly without a neuromuscular disease. The method of the present invention is based on the quantification of specified proteins. Preferably the proteins are separated and identified by 2D gel electrophoresis. 2D gel electrophoresis has been used in research laboratories for biomarker discovery since the 1970's [31-35]. In the past, this method has been considered highly specialized, labor intensive and non-reproducible.

Only recently with the advent of integrated supplies, robotics, and software combined with bioinformatics has progression of this proteomics technique in the direction of diagnostics become feasible. The promise and utility of 2D gel electrophoresis is based on its ability to detect changes in protein expression and to discriminate protein isoforms that arise due to variations in amino acid sequence and/or post-synthetic protein modifications such as phosphorylation, nitrosylation, ubiquitination, conjugation with ubiquitin-Like proteins, acetylation, and glycosylation. These are important variables in cell regulatory processes involved in disease states.

There are few comparable alternatives to 2D gels for tracking changes in protein expression patterns related to disease progression. The introduction of high sensitivity fluorescent staining, digital image processing and computerized image analysis has greatly amplified and simplified the detection of unique species and the quantification of proteins. By using known protein standards as landmarks within each gel run, computerized analysis can detect unique differences in protein expression and modifications between two samples from the same individual or between several individuals.

### Materials and Methods:

### Sample Collection and Preparation

Serum samples were prepared from blood acquired by venipuncture. The blood was allowed to clot at room temperature for 30-60 minutes, centrifuged at 1200×g for 15 minutes, and the separated serum was divided into aliquots, and frozen at 40° C. or below until shipment. Samples were shipped on dry ice and were delivered within 24 hours of shipping.

Once the serum samples were received, logged in, and assigned a sample number; they were further processed in preparation for 2D gel electrophoresis. All samples were stored at −40° C. or below. When the serum samples were removed from storage, they were placed on ice for thawing and kept on ice for further processing.

To each 100 μl of sample, 100 μl of LB-2 buffer (5M urea, 2M Thiourea, 0.5% ASB-14, 0.25% CHAPS, 0.25% Tween-20, 5% glycerol, 100 mM DTT, 1× Protease inhibitors, and 1× Ampholyte pH 3-10) was added and the mixture vortexed. The sample was incubated at room temperature for about 5 minutes.

### Separation of Proteins in Patient Samples

The proteins in the patient and control samples were separated using various techniques known in the art for separating proteins, techniques that include but are not limited to gel filtration chromatography, ion exchange chromatography, reverse phase chromatography, affinity chromatography, or any of the various centrifugation techniques well known in the art. In some cases, a combination of one or more chromatography or centrifugation steps may be combined via electrospray or nanospray with mass spectroscopy or tandem mass spectroscopy, or any protein separation technique that determines the pattern of proteins in a mixture either as a one-dimensional, two-dimensional, three-dimensional or multi-dimensional pattern or list of proteins present.

### Two Dimensional Gel Electrophoresis of Samples

Preferably the protein profiles of the present invention are obtained by subjecting biological samples to two-dimensional (2D) gel electrophoresis to separate the proteins in the biological sample into a two-dimensional array of protein spots.

Two-dimensional gel electrophoresis is a useful technique for separating complex mixtures of proteins and can be performed using a variety of methods known in the art (see, e.g., U.S. Pat. Nos. 5,534,121; 6,398,933; and 6,855,554).

Preferably, the first dimensional gel is an isoelectric focusing gel and the second dimension gel is a denaturing polyacrylamide gradient gel.

Proteins are amphoteric, containing both positive and negative charges and Like all ampholytes exhibit the property that their charge depends on pH. At low pH (acidic conditions), proteins are positively charged while at high pH (basic conditions) they are negatively charged. For every protein there is a pH at which the protein is uncharged, the protein's isoelectric point. When a charged molecule is placed in an electric field it will migrate towards the opposite charge.

In a pH gradient such as those used in the present invention, containing a reducing agent such as dithiothreitol (DTT), a protein will migrate to the point at which it reaches its isoelectric point and becomes uncharged. The uncharged protein will not migrate further and stops. Each protein will stop at its isoelectric point and the proteins can thus be separated according to their isoelectric points. In order to achieve optimal separation of proteins, various pH gradients may be used. For example, a very broad range of pH, from about 3 to 11 or 3 to 10 can be used, or a more narrow range, such as from pH 4 to 7 or 5 to 8 or 7 to 10 or 6 to 11 can be used. The choice of pH range is determined empirically and such determinations are within the skill of the ordinary practitioner and can be accomplished without undue experimentation.

In the second dimension, proteins are separated according to molecular weight by measuring mobility through a uniform or gradient polyacrylamide gel in the detergent sodium dodecyl sulfate (SDS). In the presence of SDS and a reducing agent such as dithiothreitol (DTT), the proteins act as though they are of uniform shape with the same charge to mass ratio. When the proteins are placed in an electric field, they migrate into and through the gel from one edge to the other. As the proteins migrate though the gel, individual proteins move at different speeds with the smaller ones moving faster than the larger ones. This process is stopped when the fastest moving components reach the other side of the gel. At this point, the proteins are distributed across the gel with the higher molecular weight proteins near the origin and the low molecular weight proteins near the other side of the gel.

It is well known in the art that various concentration gradients of acrylamide may be used for such protein separations. For example, a gradient of from about 5% to 20% may be used in certain embodiments or any other gradient that achieves a satisfactory separation of proteins in the sample may be used. Other gradients would include but not be limited to from about 5 to 18%, 6 to 20%, 8 to 20%, 8 to 18%, 8 to 16%, 10 to 16%, or any range as determined by one of skill.

The end result of the 2D gel procedure is the separation of a complex mixture of proteins into a two dimensional array, a pattern of protein spots, based on the differences in their individual characteristics of isoelectric point and molecular weight.

### 2D Gel Standards

Purified proteins having known characteristics are used as internal and external standards and as a calibrator for 2D gel electrophoresis. The standards consist of seven reduced, denatured proteins that can be run either as spiked internal standards or as external standards to test the ampholyte mixture and the reproducibility of the gels. A set mixture of proteins (the “standard mixture”) is used to determine pH gradients and molecular weights for the two dimensions of the electrophoresis operation. Table A lists the isoelectric point (pI) values and molecular weights for the proteins included in a particular example standard mixture.

TABLE A

| Protein | pI | Molecular Weight (Da) |
|---|---|---|
| Hen egg white conalbumin | 6.0, 6.3, 6.6 | 76,000 |
| Bovine serum albumin | 5.4, 5.5, 5.6 | 66,200 |
| Bovine muscle actin | 5.0, 5.1 | 43,000 |
| Rabbit muscle GAPDH | 8.3, 8.5 | 36,000 |
| Bovine carbonic anhydrase | 5.9, 6.0 | 31,000 |
| Soybean trypsin inhibitor | 4.5 | 21,500 |
| Equine myoglobin conalbumin | 7.0 | 17,500 |

In addition, standard mixtures such as Precision Plus Protein Standards (Bio-Rad Laboratories), a mixture of 10 recombinant proteins ranging from 10-250 kD, are typically added as external molecular weight standards for the second dimension, or the SDS-PAGE portion of the system. The Precision Plus Protein Standards have an r² value of the R_{f} vs. log molecular weight plot of >0.99.

### Separation of Proteins in Serum Samples

An appropriate amount of isoelectric focusing (IEF) loading buffer (LB-2), was added to the diluted serum sample, incubated at room temperature and vortexed periodically until the pellet was dissolved to visual clarity. The samples were centrifuged briefly before a protein assay was performed on the sample.

Approximately 100 μg of the serum proteins were suspended in a total volume of 184 μl of IEF loading buffer and 1 μl Bromophenol Blue. Each sample was loaded onto an 11 cm IEF strip (Bio-Rad Laboratories), pH 5-8, and overlaid with 1.5-3.0 ml of mineral oil to minimize the sample buffer evaporation. Using the PROTEAN® IEF Cell, an active rehydration was performed at 50V and 20° C. for 12-18 hours.

IEF strips were then transferred to a new tray and focused for 20 min at 250V followed by a linear voltage increase to 8000V over 2.5 hours. A final rapid focusing was performed at 8000V until 20,000 volt-hours were achieved. Running the IEF strip at 500V until the strips were removed finished the isoelectric focusing process.

Isoelectric focused strips were incubated on an orbital shaker for 15 min with equilibration buffer (2.5 ml buffer/strip). The equilibration buffer contained 6M urea, 2% SDS, 0.375M HC1, and 20% glycerol, as well as freshly added DTT to a final concentration of 30 mg/ml. An additional 15 min incubation of the IEF strips in the equilibration buffer was performed as before, except freshly added iodoacetamide (c₂H₄INO) was added to a final concentration of 40 mg/ml. The IPG strips were then removed from the tray using clean forceps and washed five times in a graduated cylinder containing the Bio Rad Laboratories running buffer 1× Tris-Glycine-SDS.

The washed IEF strips were then laid on the surface of Bio Rad pre-cast CRITERION SDS-gels 8-16%. The IEF strips were fixed in place on the gels by applying a low melting agarose. A second dimensional separation was applied at 200V for about one hour. After running, the gels were carefully removed and placed in a clean tray and washed twice for 20 minutes in 100 ml of pre-staining solution containing 10% methanol and 7% acetic acid.

### Staining and Analysis of the 2D Gels

Once the 2D gel patterns of the serum samples were obtained, the protein spots resolved in the gels were visualized with either a fluorescent or colored stain. In the preferred embodiment, the fluorescent dye SyproRuby™ (Bio-Rad Laboratories) was the stain. Once the protein spots had been stained, the gel was scanned by a digital fluorescent scanner or when visible dyes are employed, a digital visible light scanner, and a digital image of the protein spot pattern of the gel, i.e. a protein expression profile of the sample, was obtained.

The digital image of the scanned gel was processed using PDQuest™ (Bio-Rad Laboratories) image analysis software to first detect the proteins, locate the selected biomarkers, and then to quantitate the protein in each of the selected spots. The scanned image was cropped and filtered to eliminate artifacts using the image editing control. Individual cropped and filtered images were then placed in a matched set for comparison to other images and controls.

This process allowed quantitative and qualitative spot comparisons across gels and the determination of protein biomarker molecular weight and isoelectric point values. Multiple gel images were normalized to allow an accurate and reproducible comparison of spot quantities across two or more gels. The gels were normalized using the “total of all valid (detected and confirmed by the operator) spots method” in that a small percentage of the 1200 protein spots detected and verified change between serum samples, and that all spots detected and verified is a good estimate to correct for any differences in total protein amount applied to each gel. The quantitative amounts of the selected biomarkers present in each sample were then exported for further analysis using statistical programs.

### Initial Biomarker Selection

The 2D gel patterns of 162 serum samples collected from normal control subjects were compared with each other. The 162 normal control samples all gave similar 2D gel protein patterns. The normal protein expression pattern was then compared to the gel patterns obtained in serum samples of 186 patients diagnosed with ALS, 29 patients diagnosed with PD, 32 patients diagnosed with ALS-Like and 13 patients with PD-like disorders. The comparison of the protein expression pattern of normal controls and diseased patients identified at least 34 protein spots seen on 2D gels that differed in protein concentration.

Initially, the disease specific means, standard deviations, medians, and interquartile ranges, of the normalized concentrations of individual protein spots were used to select the biomarkers and to assess the statistical significance of concentration differences in the biomarkers between the control sera and the ALS, PD, ALS-like, PD-Like disease sera. However because of the number of biomarkers and patients in the studies, with patient to patient differences, subsequent studies used multi-variant statistical programs to select the biomarkers. Linear and quadratic single variable discriminate functional analysis was employed to determine the sensitivity, specificity, positive predictive value (PPV), and negative predictive value (NPV) of each biomarker individually, and a number of combinations of biomarkers, in multiple variable discriminant functions, were used in determining the difference between normal serum and disease serum taken from patients diagnosed with ALS, PD, ALS-like, and PD-Like disorders. Both linear and quadratic discriminant analyses were used for statistical comparison and classification of samples.

### Biostatistical Discriminant Function

The quantitative amount of the selected biomarkers present in each sample was analyzed using a biostatistical discriminant function. The concentrations for the set of selected biomarkers were entered into a discriminant biostatistical algorithm and the sample was classified as either Control, ALS, ALS-Like, PD or PD-Like disorder based on a comparison to a database of values collected from the individuals in the data set from which the discriminant function was derived.

The output of discriminant analysis is a classification table that permits the calculation of clinical sensitivity, specificity, positive predictive value (PPV) and negative predictive value (NPV). These terms are defined herein as follows: (1) the clinical sensitivity measured how often the test yielded positive results in diseased patients, for example, in the case of the present invention, patients with PD; (2) the clinical specificity measured how often the test gave negative results in non-diseased individuals, in this case non-PD patients with ALS, ALS-Like, PD-Like disorders, or normal controls; (3) the negative predictive value (NPV) measured the probability that the patient would not have the disease, in this case PD, and therefore have ALS, ALS-Like, PD-Like disorders, or be a normal control when values were restricted to all individuals who tested negative; and (4) the positive predictive value (PPV) measured the probability that the patient had the disease (e.g., PD) when values were restricted to those individuals who tested positive.

A standard discriminant function analysis was performed to determine the subset of biomarkers that would be most useful in differentiating individuals, for example those with PD, from those individuals with ALS, ALS-Like, or PD-Like disorders. Discriminant analysis has been well validated as a multivariate analysis procedure. Discriminant analysis identified sets of linearly independent functions that successfully classify individuals into a well-defined collection of groups. The statistical model used assumed a multivariate normal distribution for the set of biomarkers identified from each disease group.

Where xᵢⱼ represented the p-tuple vector of biomarkers from the i^{th} patient in the j^{th} group, j=1, [symbol] ⱼ, and represented the p-tuple centroid of the j^{th} group, made up of the mean biomarker values from the j^{th} disease group, then S represented the estimate of the within group variance-covariance matrix. The discriminant function was then that set of linear functions determined by the vector a that maximizes the quantity:

$$\frac{{n}_{1} + {n}_{2}}{{n}_{1} {n}_{2}} \frac{{[ \underline{{a}^{′}} ( {\overline{x}}_{1} - {\overline{x}}_{2} ) ]}^{2}}{{\underline{a}}^{′} S \underline{a}}$$

The outcome of the discriminant analysis was a collection of m−1 linear functions of the biomarkers (m) that maximized the ability to separate individuals into disease groups. The vector α is the p-tuple vector which contained the coefficients that, when multiplied by an individual's biomarkers serum concentrations, produced the linear discriminant function, or index that was used to classify that individual. In general, if m biomarkers are used, a maximum of (m−1, g−1) discriminant functions are determined where g represented the number of groups.

Where aⱼ(k) represented the k^{th} p-tuple discriminant function. Then the value of that discriminator for the j^{th} patient is aⱼ(k)′xᵢ. Thus for each patient there are k such values computed, which are used in a classification analysis. The discriminant functions themselves are linearly independent (i.e., for each pair of the m discriminant functions) aⱼ(k) and aⱼ(l), then a₁ (k)′aⱼ(l)=0. Thus, the m−1 discriminant functions provide incremental and non-redundant discriminant ability.

Identifying the discriminant function involved identifying the coefficients λ from the linear algebraic system of equations |H−λᵢ(H+E)|=0 where H and E were the one way analysis of variance hypotheses and error matrices respectively. It is this computation that was provided by SAS™ statistical software. The SAS software program identified the collection of best discriminators using a forward entry procedure where the p-value to enter and the p-value to stay in the model are each 0.15.

While the discrimination procedure was fairly robust in the presence of mild departures from the normality assumption, it was very sensitive to the assumption of homogeneity of variance. This means that the variance-covariance matrices of the groups between which discrimination was sought must be equal. In this circumstance, these variance-covariance matrices can be pooled. However, in the situation where the variance-covariance matrices are not equal (multivariate heteroscedasticity), this pooling procedure is suboptimal. In this circumstance, the individual variance-covariance matrices have been used.

The use of the two within-group variance-covariance matrices is an important complication in the computation of discriminant functions. When the homoscedasticity assumption is appropriate, the within group variance-covariance matrices can be pooled, producing a linear discriminant function. The use of the within-group variance-covariance matrices produced a quadratic discriminant function (i.e., where the discriminant function is a function of the squares of the proteomic measures).

### Classification Analysis

Discriminant analysis was applied to the data set, from which the contribution of each individual biomarker was determined. The SAS™ statistical software program was then used to determine the linear combinations of biomarkers that provided an optimum classification of individuals into disease groups. Alternatively, the programmer can manually select different combinations of biomarkers to be incorporated into a linear or quadratic discriminant function to optimize the classification of individuals into disease groups.

Thirty four [34] protein biomarkers were identified in the data set that both individually and/or jointly discriminated ALS and PD patient samples from each other and from samples taken from patients with ALS-ike and/or PD-Like disorders, or normal controls. Individuals were independently diagnosed as having ALS, PD, ALS-Like or AD-Like disorders, by a qualified neurologist based on the current standard of care.

### 2D Gel Electrophoretic Controls

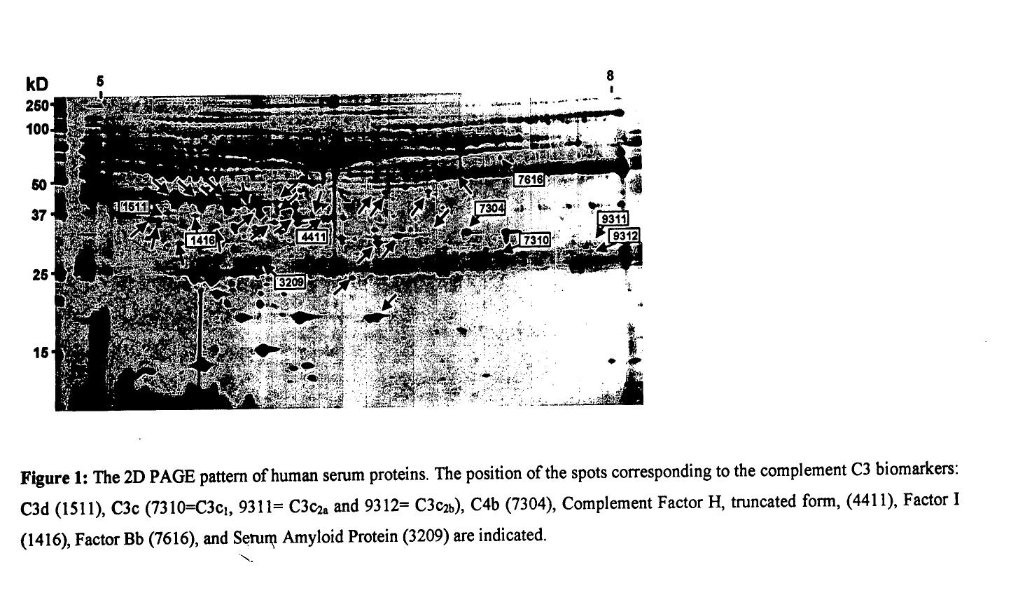

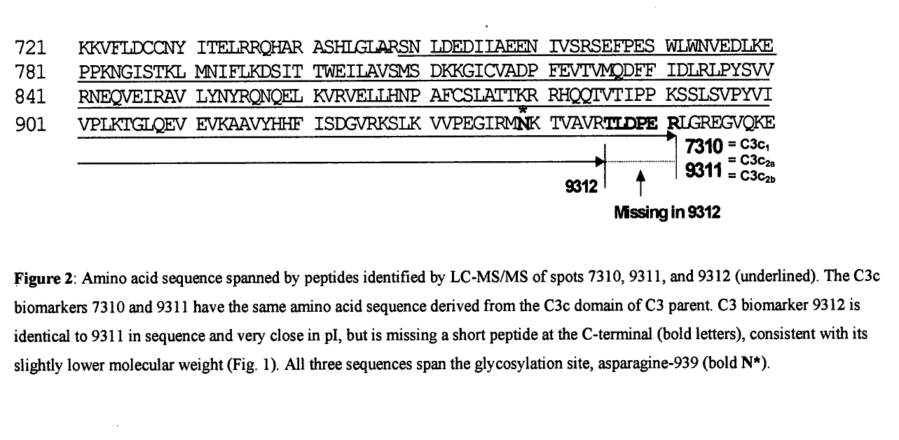

Representative samples from individuals with known cases of ALS, PD, ALS-Like, and PD-Like disorders, and normal individuals were run as positive and negative reference controls. Serum containing all of the selected biomarkers was also provided as a reference standard. A reference control was periodically run as an external standard and for tracking overall performance and reproducibility. In addition, 2D gel images from samples classified as ALS, PD, ALS-Like, and PD-Like disorders were used for reference. The spot locations for the selected biomarkers were illustrated in FIG. 1.

### The Reproducibility of Biomarker Identification and Quantification

The consistency and reproducibility of quantifying biomarkers using 2D-gel electrophoresis was characterized with samples run in replicate and each set of replicate samples was analyzed as a group. The average percent Co-efficient of Variation (% CV) is 11±7% for 10 biomarkers quantified from a single image scanned 10 times. The average %/CV is 23% for a set of biomarkers quantified from 12 separate processed aliquots of the same sample. The range in biomarker concentrations for this group of biomarkers ranged from a low of 248 ppm to a high of 15,548 ppm normalized concentration of spot per total detected spots in the 2D gel.

The protein concentrations employed in the discriminant function were relative values obtained by normalizing the intensity of each spot to all detected spots in the image. The linear range in protein concentrations was 0.5 to 1,000 ng per spot. The concentration of any given spot was the absolute amount of protein in that spot as measured by stain intensity, divided by the total protein loaded onto the gel and resolved into all detected spots. The total amount of protein loaded onto a gel was typically about 100 μg.

Serum is primarily comprised of a highly conserved distribution of the most abundant proteins, such as albumin and immunoglobulin, which enhance efforts to ensure the reproducibility and consistency of biomarker detection and quantitation. The selected biomarkers represented a minor fraction of the total serum protein. Therefore the concentration of the selected biomarkers, varied significantly as a function of disease state without significantly shifting the overall distribution and concentration of the major serum proteins. Discriminant biostatistics was employed to establish the dynamic concentration range of the selected biomarkers useful in differentiating patients and controls.

### Biomarker Stability

The effect of multiple freeze/thaw cycles on protein stability and sample integrity was investigated. A serum sample was collected and aliquoted. One aliquot was processed without freezing, while other aliquots were frozen at −80° C. and thawed repetitively. A second set of serum samples was diluted into loading buffer and aliquoted. The second set of samples, similar to the first set, had one aliquot processed without freezing and other aliquots frozen at −80° C. and thawed repetitively.

Triplicate samples were processed as described. The scanned images of the 2D gels were analyzed, and the quantities of each of the 34 neurodegenerative biomarkers of interest were determined. The results illustrated that freezing and thawing either undiluted or diluted serum samples up to 10 times had no significant effect on the serum protein profile or on the abundance of the selected biomarkers.

In addition, sample deterioration was investigated over a one-year period. Twenty-one selected biomarkers were quantitated in control samples stored at −80° C. An aliquot of each control sample was processed several times each quarter, or each 3 month time period. The results demonstrated that there was no significant increase or decrease in the quantity of biomarker detected over a one-year time frame for samples stored at −80° C., beyond that which is typically observed for processing replicate samples.

### Samples Analyzed

Serum samples were obtained from 164 sporadic ALS, 22 familial ALS, 32 ALS-Like, 29 PD, and 13 PD-Like patients and 162 normal controls. Also analyzed were 136 samples of Alzheimer's disease (AD) patients, and 16 AD-like disorder patients, as additional disease controls. All individuals with symptoms of a neurodegenerative disorder were evaluated and diagnosed by a qualified neurologist.

The AD-Like disorders included individuals with the following conditions: Lewy body dementia, Multi-infarct dementia, Alcohol-related dementia, Post-radiation Encephalopathy, Seizures, Memory dysfunction, Semantic dementia, Chronic inflammatory demyelinating polyneuropathy (CIDP), Cerebrovascular accident (CVA) dementia, Thalamic CVA, Frontotemporal dementia (FmD) and Corticalbasal danglionic degeneration (CBGD).

### Differentiating ALS PD, ALS-Like Disorders, PD-Like Disorders, and Normal Controls

The preferred embodiment used all 34 biomarkers of interest and combines disease specific single variable biomarker statistics: means, medians, inter-quartile ranges, and single variable discriminant analysis, with multivariate discriminant analysis. Although a variety of different combinations of biomarkers were also tested that gave comparable statistical performance, one combination, 13 PD optimal biomarkers is specifically described herein, but others would be performed in a similar fashion.

### The Individual Biomarkers

As shown in FIG. 1, the serum proteins were resolved by 2D gel electrophoresis of human serum proteins. The proteins were visualized by the sensitive (≦1 ng protein/spot out of 100 μg serum proteins per gel) and linearly staining (lineaiity and dynamic range of from ≦1 ng to ≧100 ng) SyproRuby™ fluorescent stain. The stained gels were scanned and the digital image of the 2D gel was analyzed using PDQuest™ quantitative digital image analysis software.

The 34 biomarkers were analyzed by excision and in-gel digestion with trypsin to produce tryptic peptides, which were then subjected to MaldiTOF MS, LC MS/MS, and database searches to identify the protein spots. The identities and electrophoretic characteristics of the Complement C3 and related biomarkers are summarized in Table 1 and their positions in the gels are shown in FIG. 1.

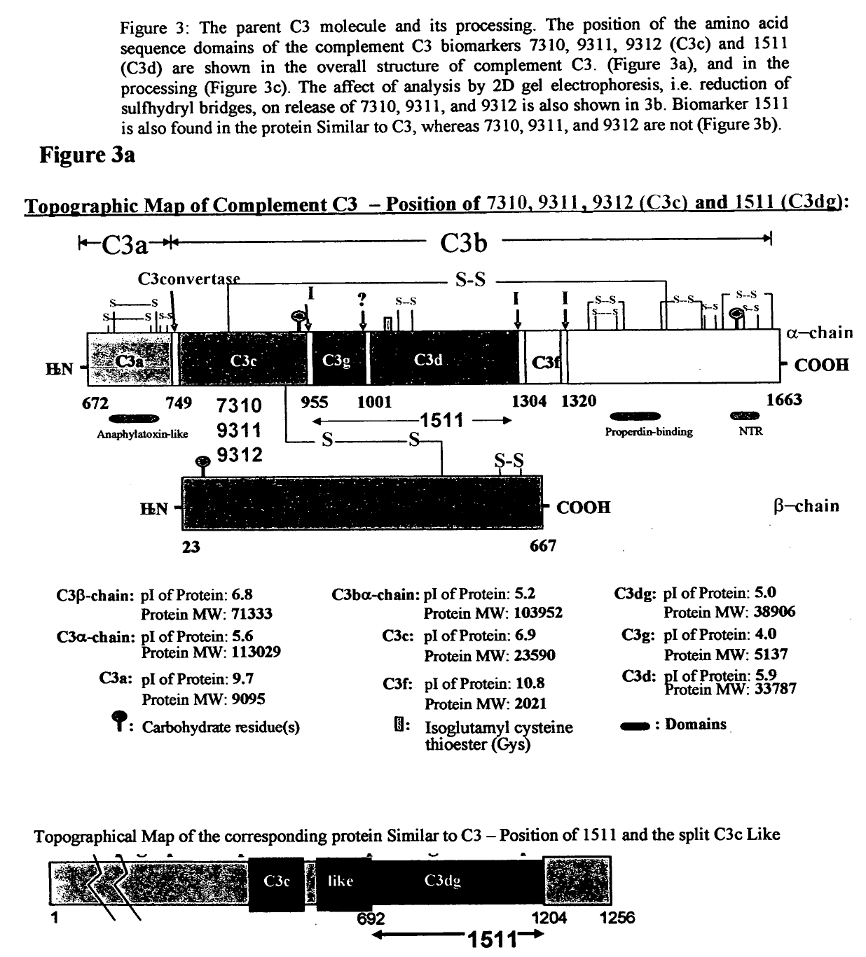

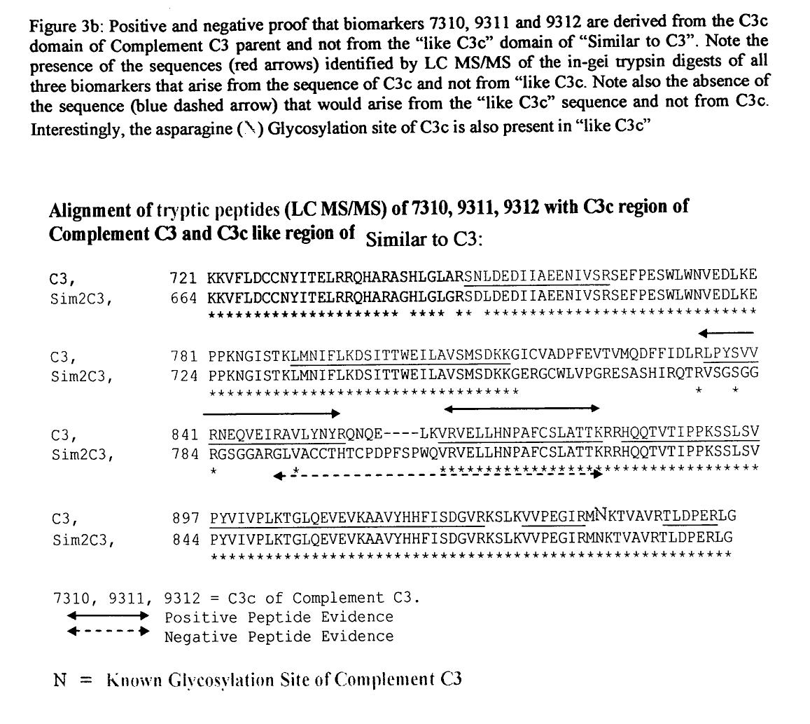

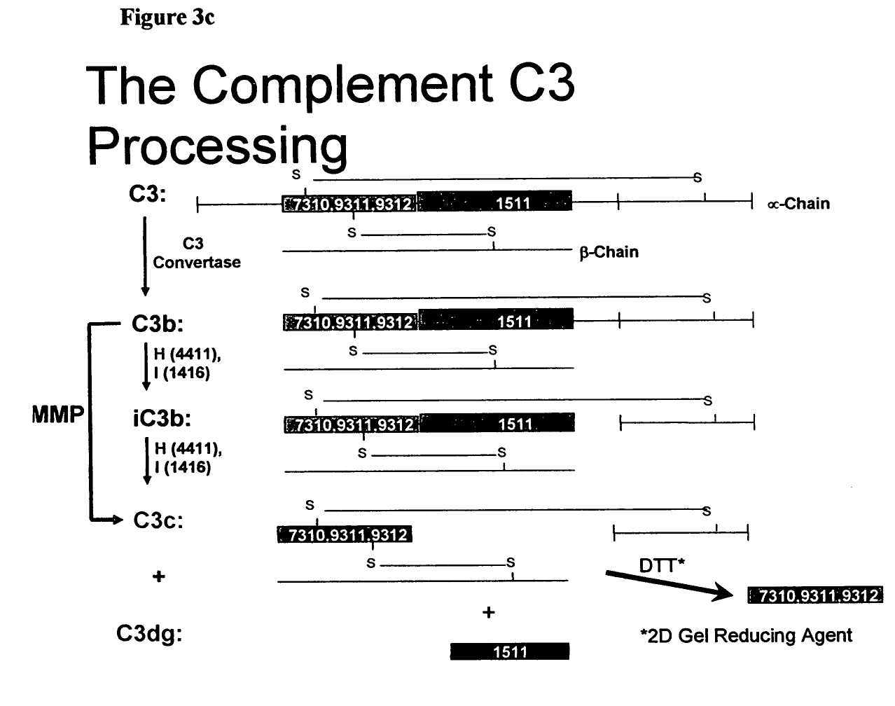

As shown in FIG. 2, all three Complement C3c spots, 7310 (C3c₁), 9311 (C3c₂ₐ), and 9312 (C3 c_{2b}) spanned the same amino acid sequence domain of the parent Complement C3 full-length transcript, that of the C3c domain. Table 2 shows that the C3c domain is adjacent to the C3dg domain, which corresponds to biomarker spot 1511. Table 3 shows the corresponding cDNA of the C3 parent protein with the positions of the coding regions for the C3c and C3dg domains. Thus recombinant genes and proteins can be designed by anyone skilled in the art to synthesize recombinant C3c and C3dg for use in immunizations to obtain specific mono or polyclonal antibodies for quantitative assay of these biomarkers in an immunoassay, a non-2D gel embodiment of the present invention. Table 4 shows the amino acid sequence of Similar to C3, which contains the C3dg domain identical to that of Complement C3 (Table 5). As shown in FIG. 3a, the C3c like domain of Similar to C3 is split, and therefore differs in that respect from C3c. FIG. 3b summarizes the peptide sequence data that confirms that C3c, not the C3c like, is the identity of biomarker spots 7310, 9311, and 9312. FIGS. 3a and 3c also show the positions, steps, and roles of C3 related proteins in the processing of Complement C3 that gives rise to the C3c and C3dg biomarkers of the present invention.

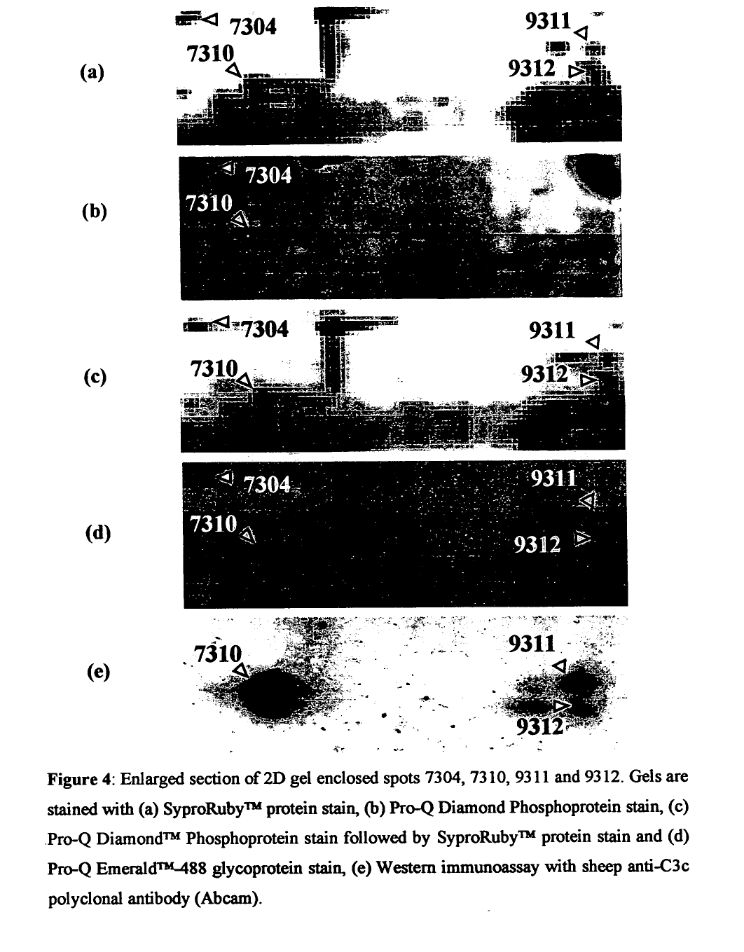

FIG. 4 summarizes the evidence that one of the C3c biomarkers, namely 7310 (designated C3c₁) differs from the other two in one respect that accounts for its 0.3 pH unit lower (more acidic) isoelectric point (FIG. 1, Table 1), i.e. the 7310 (C3c₁) biomarker is phosphorylated, whereas 9311 (C3c₂ₐ) and 9312 (C3c_{2b}) are not (FIG. 4b).

Also, shown in FIG. 4e is a positive Western immunoassay of spots 7310, 9311, and 9312, using a polyclonal antibody to Complement C3c. As a model for an immunoassay for these biomarkers, this demonstrates that 7310, 9311, and 9312 contain epitopes to raise specific monoclonal antibodies using recombinant versions of these proteins for specific immunoassays. Such recombinant proteins can also be used to purify the specific antibodies by immunoaffinity methods well known in the art.

### Single Variable Statistics

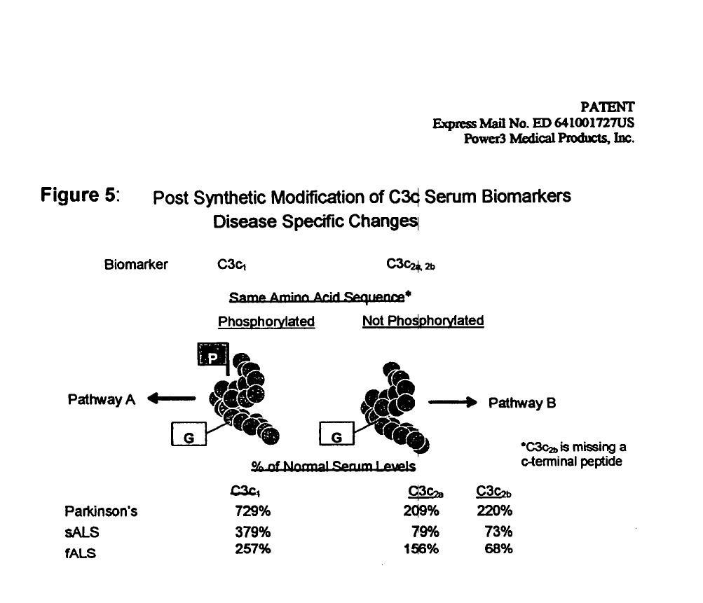

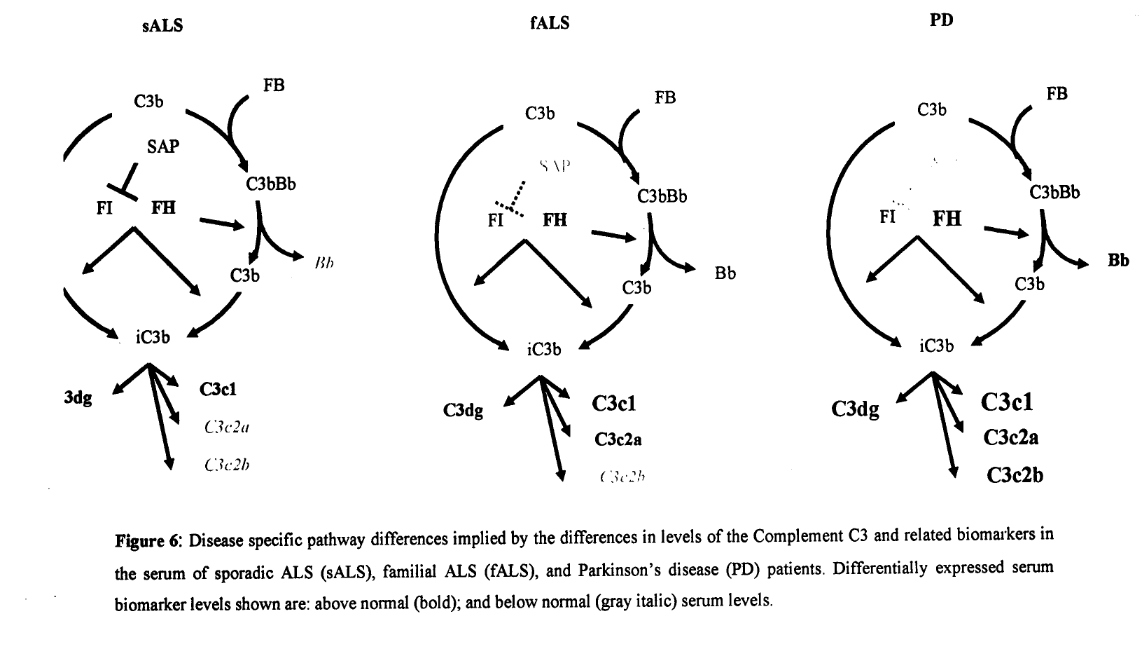

The mean quantitative level of all 34 biomarkers were tabulated for patients with ALS, PD, AD, as well as ALS-Like, PD-Like, and AD-Like disorders, and Normal subjects. As shown in FIG. 5, Table 6, and FIG. 6, there is a difference between PD, sporadic ALS, and familial ALS in the abnormal serum concentrations of the C3c's. Sporadic ALS has a mean 4 fold increase over normal controls in the serum concentration of 7310, the phosphorylated C3c₁. There is no corresponding increase, and in fact a decrease in mean serum levels of unphosphorylated C3c isoforms, 9311 (C3c₂ₐ) and 9312 (C3c_{2b}). On the other hand, Parkinson's disease has a mean 7 fold increase in 7310, phosphorylated C3c₁ and a mean 2 fold increase in unphosphorylated C3c's 9311 (C3c₂ₐ) and 9312 (C3c_{2b}). Familial ALS is somewhat in between PD and sporadic ALS with a mean 3 fold increase in 7310, phosphorylated C3c₁, a mean 1.5 fold increase in unphosphorylated C3c isoform 9311 (C3c₂ₐ), and a decrease in mean level of unphosphorylated C3c isoform 9312 (C3c_{2b}).

When the increases and/or decreases in 1511 (C3dg) from normal, 4411 (Complement Factor H short splice form), 7616 (Complement Factor Bb), and 3209 (Pre-serum Amyloid P) (see Table 6) are also taken into account, disease specific Complement C3 pathway differences are revealed (FIG. 6). These involve not only the disease specific differences in non normal levels of C3c, but also those of C3dg, as well as of the Factors H short splice form, Bb, and Pre-serum Amyloid P, all of which affect the pathways of generation of C3c and C3dg FIG. 6).

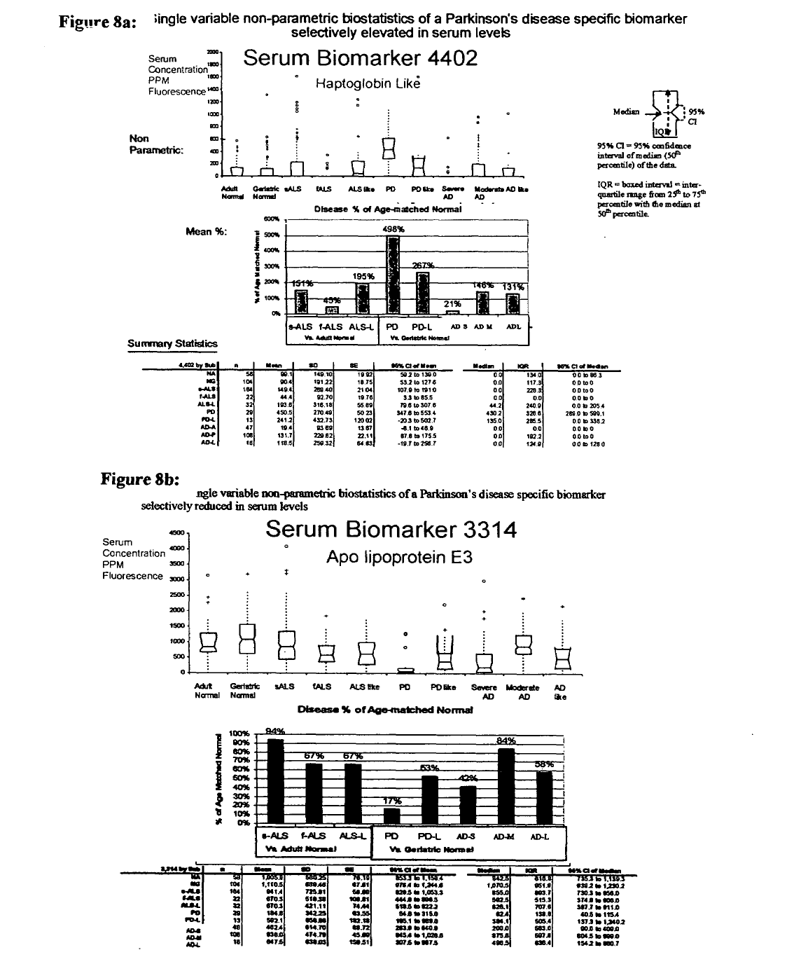

As a statistical model, the results in FIG. 8 illustrate how the distribution of the individual patients serum concentrations in each disease category, represented by the Box and Whiskers graphs, tracks with the relative means of the concentrations for each disease category, represented by the bar graphs. FIG. 8 shows the means, medians, Box and Whiskers, and summary statistics of two of the PD Optimal Biomarkers: FIG. 8a describes a biomarker that is maximally increased in levels in the serum of PD patients, spot 4402, the Haptoglobin Like protein, and FIG. 8b describes a biomarker with lowest levels in the serum of PD patients, spot 3314, Apo lipoprotein E3. Box and Whiskers plots were performed using Analyze-it™ within Microsoft Excel. A Box and Whisker plot is a way of summarizing a set of data measured on an interval scale. It is often used in explanatory data analysis. This type of graph is used to show the shape of the distribution of the data, its central value, and its variability. The upper line of the box represents the upper quartile range of data while the bottom line of the box represents the lower quartile range of the data. The whiskers are the two lines outside the box that extend to the highest and lowest observations. Clearly the bar graphs and the Box and Whiskers graphs are parallel and the means data (bars) represent significant differences, maximal (4402) or minimal (3314) for the population of PD patients, shown by the pronounced shifts of the distributions (Box and Whiskers).

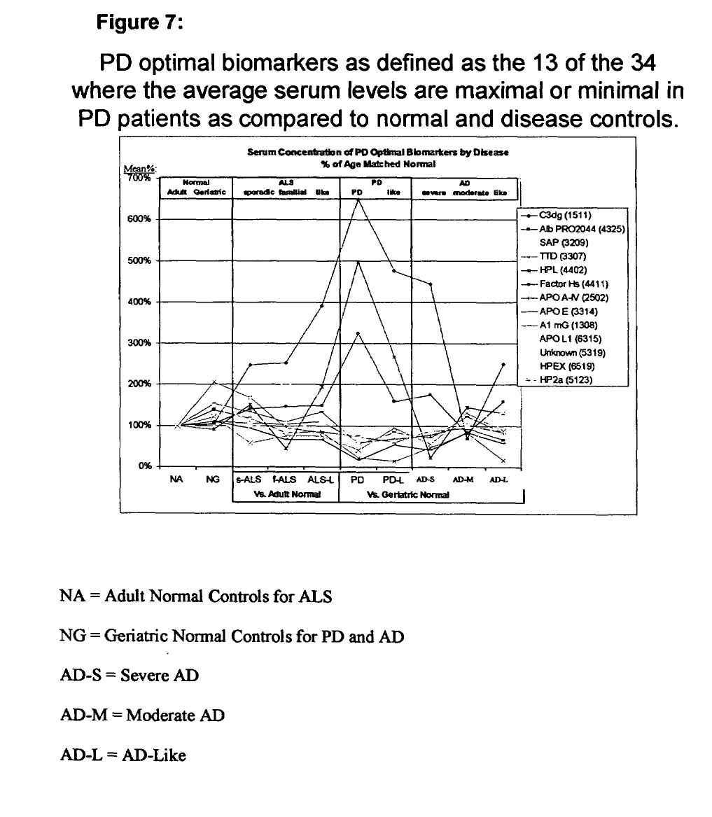

FIG. 7 shows the mean fold increase or decrease in serum levels of the 13 biomarkers of the total 34 that are either maximal or minimal in PD patients, as compared to age matched normal and disease controls. These 13 biomarkers are therefore designated as PD Optimal Biomarkers and were used for multivariate analysis as a subset of the 34 biomarkers.

### Multivariate Discriminant Biostatistics

Single variable linear discriminant analysis was performed using the SAS™ statistical software, utilizing the concentrations of each individual of the 13 PD optimal biomarkers in the serum of a Training Set consisting of 29 PD patients and 104 age matched normal controls (Table 7). The performance of each individual biomarker acting alone to discriminate PD from normal controls ranged from 48%-95% Sensitivity, and 52%-97% Specificity. Biomarkers 1511 (C3dg) (Sensitivity 95%, Specificity 72%), 4402 (Haptoglobin Like Protein, Sensitivity 86%, Specificity 76%) and 3314 (Apo lipoprotein E3, Sensitivity 74%, Specificity 90%) were the best performing. Performance of the remaining 10 PD optimal biomarkers was heavily weighted in favor of either sensitivity or specificity, or was balanced but with lower percentages (Table 7).

However, when multivariate linear discriminant analysis was performed employing the concentrations of the group of 13 PD Optimal Biomarkers together, the cumulative performance of the 13 biomarkers (Bottom of Table 7) yielded a combined sensitivity of 86% and specificity of 990% in discriminating between PD and age matched normal controls. Furthermore, when all 34 biomarkers were employed in the multivariate linear discriminant analysis, 100% combined sensitivity and 100% combined specificity were obtained for the same discrimination of the same training set (Table 8). Furthermore, when the discriminant functions obtained with the training set were challenged with samples from independent groups of patients in test sets, the performance was validated for non-age matched normal controls, PD-like, and AD disease controls (Table 8).

Similar results were obtained for ALS vs. ALS-Like patient's serum samples in a training set. Applying linear and quadratic discriminant analysis using the concentrations of the 34 biomarkers for discrimination of 145 ALS vs. 35 ALS-like patients (Table 9) linear discriminant analysis yielded a sensitivity of 69%, and a specificity of 88%, and quadratic discriminant analysis yielded 1000% sensitivity and 1000% specificity.

Usefulness of the Assays for ALS vs. ALS-Like Disorders and Normal and for PD vs. PD-Like Disorders and Normal.

Definitive diagnostic tests to confirm the diagnosis of patients with ALS or PD and distinguish them from patients with ALS-Like and/or PD-Like disorders, which display similar symptoms but have different treatment options and prognoses, have long been sought by clinicians in hopes of providing earlier treatment decisions and improved patient outcomes.

Presently, the diagnosis of ALS, PD, ALS-Like, and PD-Like disorders is a clinical one. There is no objective test that provides diagnostic accuracy. The usual diagnostic process consists of a full medical history, comprehensive physical and neurological examinations based on clinical criteria, and the results of neuro-imaging, conductivity, and analysis of cerebrospinal fluid. To date no definitive biochemical or genetic test is available to definitively diagnose ALS or PD, or to differentiate them from ALS-Like or PD-Like disorders.

The present invention provides an assay for differentiating ALS and/or PD patients from ALS-Like and/or PD-Like disorders, and from normal individuals. The assay is comprised of the following steps: (1) collecting a serum sample from a patient; (2) running triplicate 2D gel electrophoreses of the patient sample; (3) staining the 2D gel; (4) creating a digital image of the 2D gel; (5) quantifying the protein concentration in selected protein spots on the 2D gel; and (6) performing a statistical analysis on the quantity of the selected proteins to determine the Likelihood of the patient having ALS, PD or an ALS-Like, or PD-Like disorder.

While the methods have been described in terms of preferred embodiments, it will be apparent to those of skill in the art that variations may be applied to the methods including the sequence of steps in the methods. Certain agents may be substituted by one of skill and similar results may be achieved, as will be appreciated by one of skill in the art. Such modifications or substitutions to the methods of the present invention are deemed to be within the spirit, scope and concept of the invention as defined by the disclosure and its claims.

### Functional Considerations of the Utility of the C3 and Related Biomarkers to Assay Disease Burden, Drug Targeting and Response to Treatment of ALS, PD, and Like Disorders.

The serum concentrations of the C3 and related biomarkers of the present invention are useful to assess the disease processes of inflammation, immune-inflammation, oxidative stress, and inclusion body formation that are integral to neurodegeneration. Elevation of C3c and C3d cleavage products were previously observed in tissues of patients with ALS and PD by immunohistochemical studies [45-47]. Activation of the complement proteins by the alternative pathway is safeguarded by spontaneous low-rate hydrolysis of the thioester in complement C3 and the resultant continuous supply of C3(H2O). Upon the Mg²⁺-dependent binding of factor B to C3(H2O), the activation of the proenzyme complex by factor D is triggered. The resultant cleavage of B causes the release of Ba, a 30 kD fragment and the formation of C3(H2O)Bb(Mg), the initial C3 convertase, which is confined to the fluid phase. Bb, a 60 kD fragment, is the second formed as a result of the cleavage of B. It is interesting that none of the previous studies were able to detect factor Bb in neurodegenerative samples. A significant reduction in the full-length factor B in the cerebrospinal fluid (CSF) of PD patients was recently reported [48], whereas we detected elevated levels of fragment Bb of Factor B in blood serum of patients with PD and not in serum of ALS patients. This elevation of Factor Bb in PD most probably arose, at least in part, from the elevated levels of Factor H that we also detected, which has been found to induce irreversible cleavage of C3 Convertase (C3bBb(Mg²⁺))[49], liberating C3b and factor Bb, and interrupting the Alternative Pathway of the downstream Complement activation cascade.

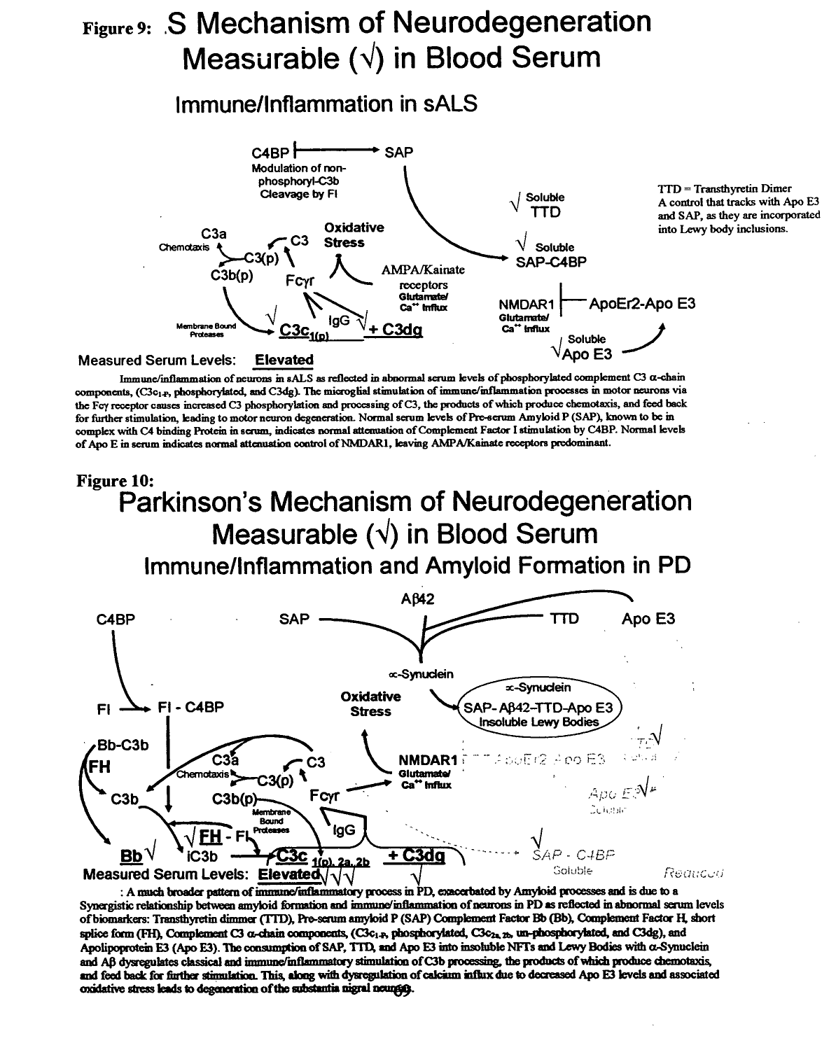

As a Complement regulatory protein, Factor H acts as a cofactor for the serine protease Factor I, which cleaves the α-chain of C3b at three sites to form iC3b, thus inhibiting the downstream Complement activation cascades. Finehout et al [48] reported a significant reduction in full-length Factor H levels in the CSF of PD and MS patients when compared to normal CSF controls, whereas the identified a cleavage product (Mwt ˜37 kD, pI 5.9) of the short spliced form of Factor H (Mwt 57.2 kD) is here disclosed as a serum biomarker that is significantly higher in the blood serum of PD and ALS patients when compared to normal serum. In addition, Pre-serum Amyloid Protein (SAP) was among the differences in serum disclosed here. It showed significant reduction in PD and familial ALS, but no difference in the more common sporatic ALS, when compared to controls. Generally, the 2-fold increased level of Complement C3dg, C3c, Factors H, and Bb, in PD over that of ALS may indicate a broader and higher level of abnormal Complement C3b processing and differential effects on the Complement cascade in PD than in ALS, possibly involving additional complement pathways in PD (FIGS. 9 and 10). Reasons for such activation are most likely due to the deposition of inclusion body proteins in PD [50] and/or the infiltration of activated astrocytes and microglial cells ALS and PD [51, 52]. In this regard, the reduced serum levels of SAP and increased serum levels of C3c₂ₐ, and/or C3c_{2b} between sALS, fALS, and PD, may reflect increased insoluble inclusion body stabilization by SAP, e.g. of neurofibrillary tangles and Lewy Bodies in PD [53, 54], as well as increased complement Factor I mediated processing of complement C3 in PD [55] (FIG. 9). In addition, the markedly reduced serum levels of Apolipoprotein E3 and Transthyretin dimmer (TTD) (FIGS. 7 and 8) are also consistent with the combination of elevated immune/inflammatory and inclusion body processes in PD which supports the integrated mechanistic relationship between these processes [56] that are reflected in the serum concentration differences of these biomarkers between ALS and PD (FIGS. 9 and 10).

These differences in serum biomarkers in patients with the two diseases may prove useful, not only for differential diagnosis, but also for measuring burden of disease, drug targeting and monitoring of therapeutic interventions [58, 59]. For example, as reflected in the mechanisms assayable with these biomarkers, therapeutic approaches for solubilizing aggregated inclusion bodies, combined with anti-inflammatory drugs to attenuate the neurodegenerative response, could be a valuable approach for future neurodegenerative therapy. Monitoring serum biomarkers may be useful to follow the response to therapy and to provide objective, quantifiable measures, as well as for discovery of new targets for early therapy of these diseases.

### REFERENCES

[1] Haverkamp L J, Appel V, Appel S H. Natural history of amyotrophic lateral sclerosis in a database population. Validation of a scoring system and a model for survival prediction. Brain. 118 (Pt 3), 707-19 (1995).
[2] Rosen D R, Siddique T, Patterson D, et al. Mutations in Cu/Zn superoxide dismutase gene are associated with familial amyotrophic lateral sclerosis. Nature. 362(6415), 59-62 (1993).
[3] Cluskey S and Ramsden D B. Mechanisms of neurodegeneration in amyotrophic lateral sclerosis. Mol Pathol. 54(6), 386-92 (2001).
[4] Orrell, R W, Habgood, J J, Gardiner, L et al. Clinical and functional investigation of 10 missense mutations and a novel frameshift insertion mutation of the gene for copper-zinc superoxide dismutase in UK families with amyotrophic lateral sclerosis. Neurology. 48(3), 746-751 (1997).
[5] Shaw C E, Enayat Z E, Chioza B A, et al. Mutations in all five exons of SOD-1 may cause ALS. Ann Neurol. 43(3), 390-394 (1998).
[6] Mulder D W, Kurland L T, Offord K P, et al. (1986) Familial adult motor neuron disease: amyotrophic lateral sclerosis. Neurology 36: 511-517.
[7] Juneja T, Pericak-Vance M A, Laing N G, et al. (1997) Prognosis in familial amyotrophic lateral sclerosis. Neurology 48: 55-57.
[8] Cudkowicz M E, McKenna-Yasek D, Sapp P E, et al. (1997) Epidemiology of mutations in superoxide dismutase in amyotrophic lateral sclerosis. Ann Neurol 41: 210-221.
[9] Li T M, Alberman E, Swash M (1988) Comparison of sporadic and familial disease amongst 580 cases of motor neuron disease. J Neurol Neurosurg Psychiatry 51: 778-784.
[10] Chaudhuri K R, Crump S, al-Sarraj S, Anderson V, Cavanagh J, Leigh P N. (1995) The validation of El Escorial criteria for the diagnosis of amyotrophic lateral sclerosis: a clinicopathological study. J Neurol Sci. May; 129 Suppl: 11-2.
[11] Brooks B R. (2000) Versailles minimal dataset for diagnosis of ALS: a distillate of the 2nd Consensus Conference on accelerating the diagnosis of ALS. Versailles 2nd Consensus Conference participants. Amyotroph Lateral Scler Other Motor Neuron Disord. March, 1 Suppl 1:S79-81. Review.
[12] Rothstein J D, Van Kammen M, Levey A I, Martin L J and Kuncl R W. Selective loss of glial glutamate transporter GLT-1 in amyotrophic lateral sclerosis. Ann Neurol. 38(1), 73-84 (1995).
[13] Siklos L, Engelhart J I, Alexianu M E, Gurney M E, Siddique T, Appel S H. Intracellular calcium parallels motor neuron degradation in SOD 1 mutant mice. J Neuropath E-x Neurol. 57, 571-587 (1998).
[14] Simpson E P, Yen A A, Appel S H. Oxidative Stress: a common denominator in the pathogenesis of amyotrophic lateral sclerosis. Curr Opin Rheumatol. 15(6), 730-6 (2003).
[15] Al-Chalabi A, Andersen P M, Nilsson P, et al. Deletions of the heavy neurofilament subunit tail in amyotrophic lateral sclerosis. Hum Mol Genet. 8(2), 157-164 (1999).
[16] Henkel J S, Engelhardt J I, Siklos L, et al. Presence of dendritic cells, MCP-1, and activated microglia/macrophages in amyotrophic lateral sclerosis spinal cord tissue. Ann Neurol. 55(2), 221-35 (2004).
[17] Pullen A H K Demestre M, Howard R L, Orel R W. Passive transfer of purified IgG from patients with Amyotrophic Lateral Sclerosis to mice results in degradaztion of motor neurons by Ca²⁺ enhancement. Acta Neuropathol. 107, 35-46 (2004).
[18] Alexianu M E, Mohamed A H, Glenn Smith R, Column L V, Appel, S H. Apototic cell death of hybrid motor neuron cell line induced by immunoglobulins from patients with Amyotrophic Lateral Sclerosis. J. Neurochem. 63, 2365-2368 (1994).
[19] Bruijn L I, Miller T M, Cleveland D W. Unraveling the mechanisms involved in motor neuron degeneration in ALS. Annu Rev Neurosci. 27, 723-749 (2004).
[20] T. M. Dawson, and V. L. Dawson, Molecular pathways of neurodegeneration in Parkinson's disease, Science. 302 (2003), pp. 819-822.
[21] Hughes A J, Daniel S E, Kilford L, Lees A J. (1992) Accuracy of clinical diagnosis of idiopathic Parkinson's disease: a clinico-pathological study of 100 cases. J Neurol Neurosurg Psychiatry, 55:181.
[22] Rajput A R, Rozdilsky B, Rajput A. (1991) Accuracy of clinical diagnosis in parkinsonism: a prospective study. Can J Neurol Sci., 18:275.
[23] Steven A. Kaplan. (2000) Managing Incontinence in People with Parkinson's Disease. Loss, Grief & Care, 8 (3-4):93-97.
[24] Steele P E, Tang P H, DeGrauw A J, Miles M V (2004) Clinical laboratory monitoring of coenzyme Q10 use in neurologic and muscular diseases. Am J Clin Pathol., 121 Suppl:S1 13-20.
[25] Samii A, Nutt J G, Ransom B R (2004) Parkinson's disease. Lancet. 29; 363(9423): 1783-93.
[26] Quinn N (ed), Parkinsonism, Balliere's Clinical Neurology, Balliere Tindall, 1997 ISBN: 0 7020 2309 4.
[27] Petricoin E, Ardekani B, Hitt P, Levine V, Fusaro S, Steinberg S, Mills G, Simone C, Fishman D, Kohn E. Use of proteonomic patterns in serum to identify ovarian cancer. Lancet 359, 572-577 (2002).
[28] Lewczuk P, Esselmann H, Groemer T W, Bibl M, Maler J M, Steinacker P, Otto M, Korrhuber J, Wiltfang J. Amyloid beta peptides in cerebrospinal fluid as profiled with surface enhanced laser desorption/ionization time-of-flight mass spectrometry: evidence of novel biomarkers in Alzheimer's disease. Biol. Psychiatry 55:524-530 (2004.
[29] Kuerer H M, Goldknopf I L, Fritsche H, Krishnamurthy S, Sheta E A, Hunt K K. Identification of distinct protein expression patterns in bilateral matched pair breast ductal fluid specimens from women with unilateral invasive breast carcinoma. High-throughput biomarker discovery. Cancer 95:2276-2282 (2002).
[30] Ueno L Sakai T, Yamaoka M, Yoshida R, Tsugita A. Analysis of blood plasma proteins in patients with Alzheimer's disease by two-dimensional electrophoresis, sequence homology and immunodetection. Electrophoresis 21:1832-1845 (2000).
[31] Orrick L R, Olson M O J, and Busch H Comparison of nucleolar proteins of normal rat liver and Novikoff hepatoma ascites cells by two-dimensional polyacrylamide gel electrophoresis, Proc Natl Acad Sci USA. 70 (1973), pp. 1316-1320.
[32] Goldknopf I L, Taylor C W, Baum R M, Yeoman L C, Olson M O J, Prestayko A W, and Busch H, Isolation and characterization of protein A24, a “histone-like” non-histone chromosomal protein, J Biol Chem. 250 (1975), pp. 7182-7187.
[33] Goldknopf I L, and Busch H, Isopeptide linkage between non-histone and histone 2A polypeptides of chromosomal conjugate-protein A24, Proc Natl Acad Sci USA. 74 (1977), pp. 5492-5495.
[36] O'Farrell P H, High resolution two-dimensional electrophoresis of proteins. J. Biol. Chem. 250, 40074021 (1975).
[34] Anderson L, and Anderson N G, High resolution two-dimensional electrophoresis of human plasma proteins, Proc Natl Acad Sci USA. 74, 864-868 (1977).
[35] Klose J, Protein mapping by combined isoelectric focusing and electrophoresis of mouse tissues. A novel approach to testing for induced point mutations in mammals, Human Genetic. 26, 231-243 (1975).
[37] Raymond S, Protein Purification by Elution Convection Electrophoresis, Science 146, 406-407 (1964).
[38] Margolis J, and Kenrick K G, 2-dimensional resolution of plasma proteins by combination of polyacrylamide disc and gradient gel electrophoresis, Nature. 221, 1056-1057 (1969).
[39] Aebersold R, Man, M. Mass spectrometry-based proteomics, Nature, 422, 198-207 (2003).
[40] Kuruma H, Egawa S, Oh-Shi M, Kodera Y, Maeda T. Proteome Analysis of prostate cancer, Prostate Cancer and Prostatic Disease, 1, 1-8 (2004).
[41] White C N, Chan D W, Zhang Z. Bioinformatics strategies for protein profiling, Clinical Biochemistry, 37: 636-641 (2004).
[42] Anderson N L and Anderson N G. (2002) The Human Plasma Proteome History, Character, and Diagnostic Prospects. Molecular & Cellular Proteomics 1:845-867, (2002).
[43] Goldknopf I L, Sheta E A, Bryson J, Folsom B, Wilson C, Duty J, A. Yen A A, Appel S H, Complement C3c and related protein biomarkers in amyotrophic lateral sclerosis and Parkinson's disease, Biochem. Biophys. Res. Commun. 342, 1034-1039 (2006).
[44] Sheta E A, Appel S H, Goldknopf I L, 2D gel blood serum biomarkersreveal differential clinical proteomics of the neurodegenerative diseases, Expert Rev. Proteomics 3, 45-2 (2006).
[45] Kawamata T, Akiyama I L Yamada T and McGeer P L. Immunologic reactions in amyotrophic lateral sclerosis brain and spinal cord tissue. Am J Pathol. 140(3), 691-707 (1992).
[46] Schwab C, Steele J C and McGeer P L. Neurofibrillary tangles of Guam parkinson-dementia are associated with reactive microglia and complement proteins. Brain Res. 707(2), 196-205 (1996).
[47] Yamada T, McGeer P L and McGeer E G. Lewy bodies in Parkinson's disease are recognized by antibodies to complement proteins. Acta Neuropathol (Berl). 84(1), 100-104 (1992).
[48] Finehout E J, Franck Z and Lee K H. Complement protein isoforms in CSF as possible biomarkers for neurodegenerative disease. Dis Markers. 21(2), 93-101 (2005).
[49] Hourcade D E, Mitchell L, Kuttner-Kondo L A, Atkinson J P and Medof M E. Decay-accelerating factor (DAF), complement receptor 1 (CR1), and factor H dissociate the complement AP C3 convertase (C3bBb) via sites on the type A domain of Bb. J Biol Chem. 277(2), 1107-1112 (2002).
[50] Rus H and Niculescu F. The complement system in central nervous system diseases. Immunol Res. 24(1), 79-86 (2001).
[51] Loeffler D A, Camp D M, Schonberger M B, Singer D J and LeWitt P A. Early complement activation increases in the brain in some aged normal subjects. Neurobiol Aging. 25(8), 1001-1007 (2004).
[52] Veerhuis R, Van Breemen M J, Hoozemans J M, et al. Amyloid beta plaque-associated proteins C1q and SAP enhance the Abeta1-12 peptide-induced cytokine secretion by adult human microglia in vitro. Acta Neuropathol (Berl). 105(2), 135-144 (2003).
[53] Lippa S M, Lippa C F, and Mori H. Alpha-synuclein aggregation in pathological aging and Alzheimer's disease: the impact of beta-amyloid plaque level. Am. J. Alzheimers Dis. Other Demen. 20, 315-318 (2005).
[54] Yagi H, Kusaka E, Kunihiro H, Mizobata T, and Kawata Y. Amyloid fibril formation od α-synuclein is accelerated by amyloid seeds of other proteins, J. Biol. Chem. 280, 38609-38616 (2005).
[55] de Frutos P G, Hardig Y and Dahlback B. Serum amyloid P component binding to C4b-binding protein. J. Biol. Chem. 45, 26950-26955 (1995).
[56] Gee J R and Keller J N. Astrocytes: regulation of brain homeostasis via apolipoprotein E. Int. J. Biochem. Cell Biol. 37, 1145-1150 (2005).
[57] Henkel J S, Engelhardt J I, Siklos L, et al. Presence of dendritic cells, and activated microglia macrophages, in amylotrophic lateral sclerosis spinal cord tissue. Ann. Neurol. 55, 221-235 (2004).
[58] Simpson E P, Henry Y K, Henkel J S, Smith R G, and Appel S H. Increased lipid peroxidation in sera of ALS patients: a potential biomarker of disease burden. Neurology 62, 1758-1765 (2004).

TABLE 1
List of complement C3 and related protein biomarkers identified by MADLI-TOF and LC-MS/MS

| | | | NCBI | | Actual 2D | LC-MS/MS | % | LC-MS/MS |
|---|---|---|---|---|---|---|---|---|
| Spot | Protein ID | | Accession | Calculated | gel Mwt | total | Sequence | Peptides |
| # | MALD-TOF Protein ID | LC-MS/MS sequence ID | # | Mwt(kD)/pI | (kD)/pI | score | coverage | matched |
| 7310 | Complement C3 | Complement C3c | 40786791 | 24/6.9 | 30.0/7.2 | 647 | 12 | 20 |
| 9311 | Complement C3 | Complement C3c | 40786791 | 24/6.9 | 32.0/7.5 | 555 | 12 | 14 |
| 9312 | Complement C3 | Complement C3c | 40786791 | 24/6.9 | 30.0/7.5 | 519 | 11 | 12 |
| 1511 | Complement C3 and | Complement C3dg | 40786791 | 39/5.0 | 37.0/5.1 | 161 | 20.7 | 7 |
| | Similar to Complement C3 | | 55648063 | | | | | |
| 7304 | Complement C4b | Complement C4b γ-chain | 55961839 | 31/7.1 | 34.0/7.1 | 382 | 9.5 | 10 |
| 4411 | Complement Factor H, short | Complement Factor H fragment | 2144888 | 34/5.7 | 37.0/5.9 | 542 | 67.5 | 15 |
| | spliced form | | | | | | | |
| 1416 | Complement Factor I | Complement Factor I light chain | 4504579 | 28/6.2 | 38/5.1 | 183 | 26.8 | 7 |
| 7616 | Complement factor B, | Complement factor Bb | 14124934 | 57/7.3 | 62/7.2 | 976 | 49 | 30 |
| | preproprotein | | | | | | | |
| 3209 | Serum Amyloid P component | Full length | 337758 | 25/6.1 | 29.0/6.1 | 429 | 88 | 12 |

TABLE 2

Complement C3: [spots 7310, 9311, 9312, 1511]
Alternative Names:
C3 C3b
C3 DEFICIENCY, AUTOSOMAL RECESSIVE
COMPLEMENT COMPONENT 3 DEFICIENCY, AUTOSOMAL RECESSIVE
acylation-stimulating protein cleavage product
complement component 3 precursor
complement component C3
Complement C3c = Biomarker spots 7310, 9311, 9312
Complement C3dg = Biomarker spot 1511
AA Sequence: Accession # 40786791:
LC/MS/MS Identified peptides spanning the highlighted red

| | |
|---|---|
| 1 | MGPTSGPSLL LLLLTHLPLA LGSPMYSIIT PNILRLESEE TMVLEAHDAQ GDVPVTVTVH |
| 61 | DFPGKKLVLS SEKTVLTPAT NHMGNVTFTI PANREFKSEK GRNKFVTVQA TFGTQVVEKV |
| 121 | VLVSLQSGYL FIQTDKTIYT PGSTVLYRIF TVNHKLLPVG RTVMVNIENP EGIPVKQDSL |
| 181 | SSQNQLGVLP LSWDIPELVN MGQWKIRAYY ENSPQQVFST EFEVKEYVLP SFEVIVEPTE |
| 241 | KFYYIYNEKG LEVTITARFL YGKKVEGTAF VIFGIQDGEQ RISLPESLKR IPIEDGSGEV |
| 301 | VLSRKVLLDG VQNPRAEDLV GKSLYVSATV ILHSGSDMVQ AERSGIPIVT SPYQIHFTKT |
| 361 | PKYFKPGMPF DLMVFVTNPD GSPAYRVPVA VQGEDTVQSL TQGDGVAKLS INTHPSQKPL |
| 421 | SITVRTKKQE LSEAEQATRT MQALPYSTVG NSNNYLHLSV LRTELRPGET LNVNFLLRMD |
| 481 | RAHEAKIRYY TYLIMNKGRL LKAGRQVREP GQDLVVLPLS ITTDFIPSFR LVAYYTLIGA |
| 541 | SGQREVVADS VWVDVKDSCV GSLVVKSGQS EDRQPVPGQQ MTLKIEGDHG ARVVLVAVDK |
| 601 | GVFVLNKKNK LTQSKIWDVV EKADIGCTPG SGKDYAGVFS DAGLTFTSSS GQQTAQRAEL |
| 661 | QCPQPAARRR RSVQLTEKRM DKVGKYPKEL RKCCEDGMRE NPMRFSCQRR TRFISLGEAC |
| 721 | KKVFLDCCNY ITELRRQHAR ASHLGLARSN LDEDIIAEEN IVSRSEFPES WLWNVEDLKE |
| 781 | PPKNGISTKL MNIFLKDSIT TWEILAVSMS DKKGICVADP FEVTVMQDFF IDLRLPYSVV |
| 841 | RNEQVEIRAV LYNYRQNQEL KVRVELLHNP AFCSLATTKR RHQQTVTIPP KSSLSVPYVI |
| 901 | VPLKTGLQEV EVKAAVYHHF ISDGVRKSLK VVPEGIRMNK TVAVRTLDPE RLGREGVQKE |
| 961 | DIPPADLSDQ VPDTESETRI LLQGTPVAQM TEDAVDAERL KHLIVTPSGC GEQNMIGMTP |
| 1021 | TVIAVHYLDE TEQWEKFGLE KRQGALELIK KGYTQQLAFR QPSSAFAAFV KRAPSTWLTA |
| 1081 | YVVKVFSLAV NLIAIDSQVL CGAVKWLILE KQKPDGVFQE DAPVIHQEMI GGLRNNNEKD |
| 1141 | MALTAFVLIS LQEAKDICEE QVNSLPGSIT KAGDFLEANY MNLQRSYTVA IAGYALAQMG |
| 1201 | RLKGPLLNKF LTTAKDKNRW EDPGKQLYNV EATSYALLAL LQLKDFDFVP PVVRWLNEQR |
| 1261 | YYGGGYGSTQ ATFMVFQALA QYQKDAPDHQ ELNLDVSLQL PSRSSKITHR IHWESASLLR |
| 1321 | SEETKENEGF TVTAEGKGQG TLSVVTMYHA KAKDQLTCNK FDLKVTIKPA PETEKRPQDA |
| 1381 | KNTMILEICT RYRGDQDATM SILDISMMTG FAPDTDDLKQ LANGVDRYIS KYELDKAFSD |
| 1441 | RNTLIIYLDK VSHSEDDCLA FKVHQYFNVE LIQPGAVKVY AYYNLEESCT RFYHPEKEDG |
| 1501 | KLNKLCRDEL CRCAEENCFI QKSDDKVTLE ERLDKACEPG VDYVYKTRLV KVQLSNDFDE |
| 1561 | YIMAIEQTIK SGSDEVQVGQ QRTFISPIKC REALKLEEKK HYLMWGLSSD FWGEKPNLSY |
| 1621 | IIGKDTWVEH WPEEDECQDE ENQKQCQDLG AFTESMVVFG CPN |

UNDERLINED SEQUENCE SPANS THE COMPLEMENT C3c FRAGMENT
BLUE RESIDUES SPAN THE SEQUENCE COMPLEMENT OF C3dg FRAGMENT

TABLE 3
cDNA Full length of Complement C3: Sequence should start and end (red nucleotides) to span
the entire sequence of C3c fragment: starting at Serine (S) amino acid residue #749 to
arginine residue [R] #954 for a total of 206 amino acids. For C3dg,
sequence should start and ends at blue nucleotides.

http://www.ncbi.nlm.nih.gov/entrez/viewer.fcgi?
val = 4557384 & itemID = 1 & view = gbwithparts

| | | |
|---|---|---|
| 1 | ATGGGACCCA CCTCAGGTCC CAGCCTGCTG CTCCTGCTAC TAACCCACCT CCCCCTGGCT | |
| 61 | CTGGGGAGTC CCATGTACTC TATCATCACC CCCAACATCT TGCGGCTGGA GAGCGAGGAG | |
| 121 | ACCATGGTGC TGGAGGCCCA CGACGCGCAA GGGGATGTTC CAGTCACTGT TACTGTCCAC | |
| 181 | GACTTCCCAG GCAAAAAACT AGTGCTGTCC AGTGAGAAGA CTGTGCTGAC CCCTGCCACC | |
| 241 | AACCACATGG GCAACGTCAC CTTCACGATC CCAGCCAACA GGGAGTTCAA GTCAGAAAAG | |
| 301 | GGGCGCAACA AGTTCGTGAC CGTGCAGGCC ACCTTCGGGA CCCAAGTGGT GGAGAAGGTG | |
| 361 | GTGCTGGTCA GCCTGCAGAG CGGGTACCTC TTCATCCAGA CAGACAAGAC CATCTACACC | |
| 421 | CCTGGCTCCA CAGTTCTCTA TCGGATCTTC ACCGTCAACC ACAAGCTGCT ACCCGTGGGC | |
| 481 | CGGACGGTCA TGGTCAACAT TGAGAACCCG GAAGGCATCC CGGTCAAGCA GGACTCCTTG | |
| 541 | TCTTCTCAGA ACCAGCTTGG CGTCTTGCCC TTGTCTTGGG ACATTCCGGA ACTCGTCAAC | |
| 601 | ATGGGCCAGT GGAAGATCCG AGCCTACTAT GAAAACTCAC CACAGCAGGT CTTCTCCACT | |
| 661 | GAGTTTGAGG TGAAGGAGTA CGTGCTGCCC AGTTTCGAGG TCATAGTGGA GCCTACAGAG | |
| 721 | AAATTCTACT ACATCTATAA CGAGAAGGGC CTGGAGGTCA CCATCACCGC CAGGTTCCTC | |
| 781 | TACGGGAAGA AAGTGGAGGG AACTGCCTTT GTCATCTTCG GGATCCAGGA TGGCGAACAG | |
| 841 | AGGATTTCCC TGCCTGAATC CCTCAAGCGC ATTCCGATTG AGGATGGCTC GGGGGAGGTT | |
| 901 | GTGCTGAGCC GGAAGGTACT GCTGGACGGG GTGCAGAACC TCCGAGCAGA AGACCTGGTG | |
| 961 | GGGAAGTCTT TGTACGTGTC TGCCACCGTC ATCTTGCACT CAGGCAGTGA CATGGTGCAG | |
| 1021 | GCAGAGCGCA GCGGGATCCC CATCGTGACC TCTCCCTACC AGATCCACTT CACCAAGACA | |
| 1081 | CCCAAGTACT TCAAACCAGG AATGCCCTTT GACCTCATGG TGTTCGTGAC GAACCCTGAT | |
| 1141 | GGCTCTCCAG CCTACCGAGT CCCCGTGGCA GTCCAGGGCG AGGACACTGT GCAGTCTCTA | |
| 1201 | ACCCAGGGAG ATGGCGTGGC CAAACTCAGC ATCAACACAC ACCCCAGCCA GAAGCCCTTG | |
| 1261 | AGCATCACGG TGCGCACGAA GAAGCAGGAG CTCTCGGAGG CAGAGCAGGC TACCAGGACC | |
| 1321 | ATGCAGGCTC TGCCCTACAG CACCGTGGGC AACTCCAACA ATTACCTGCA TCTCTCAGTG | |
| 1381 | CTACGTACAG AGCTCAGACC CGGGGAGACC CTCAACGTCA ACTTCCTCCT GCGAATGGAC | |
| 1441 | CGCGCCCACG AGGCCAAGAT CCGCTACTAC ACCTACCTGA TCATGAACAA GGGCAGGCTG | |
| 1501 | TTGAAGGCGG GACGCCAGGT GCGAGAGCCC GGCCAGGACC TGGTGGTGCT GCCCCTGTCC | |
| 1561 | ATCACCACCG ACTTCATCCC TTCCTTCCGC CTGGTGGCGT ACTACACGCT GATCGGTGCC | |
| 1621 | AGCGGCCAGA GGGAGGTGGT GGCCGACTCC GTGTGGGTGG ACGTCAAGGA CTCCTGCGTG | |
| 1681 | GGCTCGCTGG TGGTAAAAAG CGGCCAGTCA GAAGACCGGC AGCCTGTACC TGGGCAGCAG | |
| 1741 | ATGACCCTGA AGATAGAGGG TGACCACGGG GCCCGGGTGG TACTGGTGGC CGTGGACAAG | |
| 1801 | GGCGTGTTCG TGCTGAATAA GAAGAACAAA CTGACGCAGA GTAAGATCTG GGACGTGGTG | |
| 1861 | GAGAAGGCAG ACATCGGCTG CACCCCGGGC AGTGGGAAGG ATTACGCCGG TGTCTTCTCC | |
| 1921 | GACGCAGGGC TGACCTTCAC GAGCAGCAGT GGCCAGCAGA CCGCCCAGAG GGCAGAACTT | |
| 1981 | CAGTGCCCGC AGCCAGCCGC CCGCCGACGC CGTTCCGTGC AGCTCACGGA GAAGCGAATG | |
| 2041 | GACAAAGTCG GCAAGTACCC CAAGGAGCTG CGCAAGTGCT GCGAGGACGG CATGCGGGAG | |
| 2101 | AACCCCATGA GGTTCTCGTG CCAGCGCCGG ACCCGTTTCA TCTCCCTGGG CGAGGCGTGC | |
| 2161 | AAGAAGGTCT TCCTGGACTG CTGCAACTAC ATCACAGAGC TGCGGCGGCA GCACGCGCGG | |
| 2221 | GCCAGCCACC TGGGCCTGGC CAGGAGTAAC CTGGATGAGG ACATCATTGC AGAAGAGAAC | C3c STARTS |
| 2281 | ATCGTTTCCC GAAGTGAGTT CCCAGAGAGC TGGCTGTGGA ACGTTGAGGA CTTGAAAGAG | |
| 2341 | CCACCGAAAA ATGGAATCTC TACGAAGCTC ATGAATATAT TTTTGAAAGA CTCCATCACC | |
| 2401 | ACGTGGGAGA TTCTGGCTGT CAGCATGTCG GACAAGAAAG GGATCTGTGT GGCAGACCCC | |
| 2461 | TTCGAGGTCA CAGTAATGCA GGACTTCTTC ATCGACCTGC GGCTACCCTA CTCTGTTGTT | |
| 2521 | CGAAACGAGC AGGTGGAAAT CCGAGCCGTT CTCTACAATT ACCGGCAGAA CCAAGAGCTC | |
| 2581 | AAGGTGAGGG TGGAACTACT CCACAATCCA GCCTTCTGCA GCCTGGCCAC CACCAAGAGG | |
| 2641 | CGTCACCAGC AGACCGTAAC CATCCCCCCC AAGTCCTCGT TGTCCGTTCC ATATGTCATC | |
| 2701 | GTGCCGCTAA AGACCGGCCT GCAGGAAGTG GAAGTCAAGG CTGCCGTCTA CCATCATTTC | |
| 2761 | ATCAGTGACG GTGTCAGGAA GTCCCTGAAG GTCGTGCCGG AAGGAATCAG AATGAACAAA | |
| 2821 | ACTGTGGCTG TTCGCACCCT GGATCCAGAA CGCCTGGGCC GTGAAGGAGT GCAGAAAGAG | C3c ENDS; C3dg STARTS |
| 2881 | GACATCCCAC CTGCAGACCT CAGTGACCAA GTCCCGGACA CCGAGTCTGA GACCAGAATT | |
| 2941 | CTCCTGCAAG GGACCCCAGT GGCCCAGATG ACAGAGGATG CCGTCGACGC GGAACGGCTG | |
| 3001 | AAGCACCTCA TTGTGACCCC CTCGGGCTGC GGGGAACAGA ACATGATCGG CATGACGCCC | |
| 3061 | ACGGTCATCG CTGTGCATTA CCTGGATGAA ACGGAGCAGT GGGAGAAGTT CGGCCTAGAG | |
| 3121 | AAGCGGCAGG GGGCCTTGGA GCTCATCAAG AAGGGGTACA CCCAGCAGCT GGCCTTCAGA | |
| 3181 | CAACCCAGCT CTGCCTTTGC GGCCTTCGTG AAACGGGCAC CCAGCACCTG GCTGACCGCC | |
| 3241 | TACGTGGTCA AGGTCTTCTC TCTGGCTGTC AACCTCATCG CCATCGACTC CCAAGTCCTC | |
| 3301 | TGCGGGGCTG TTAAATGGCT GATCCTGGAG AAGCAGAAGC CCGACGGGGT CTTCCAGGAG | |
| 3361 | GATGCGCCCG TGATACACCA AGAAATGATT GGTGGATTAC GGAACAACAA CGAGAAAGAC | |
| 3421 | ATGGCCCTCA CGGCCTTTGT TCTCATCTCG CTGCAGGAGG CTAAAGATAT TTGCGAGGAG | |
| 3481 | CAGGTCAACA GCCTGCCAGG CAGCATCACT AAAGCAGGAG ACTTCCTTGA AGCCAACTAC | |
| 3541 | ATGAACCTAC AGAGATCCTA CACTGTGGCC ATTGCTGGCT ATGCTCTGGC CCAGATGGGC | |
| 3601 | AGGCTGAAGG GGCCTCTTCT TAACAAATTT CTGACCACAG CCAAAGATAA GAACCGCTGG | |
| 3661 | GAGGACCCTG GTAAGCAGCT CTACAACGTG GAGGCCACAT CCTATGCCCT CTTGGCCCTA | |
| 3721 | CTGCAGCTAA AAGACTTTGA CTTTGTGCCT CCCGTCGTGC GTTGGCTCAA TGAACAGAGA | |
| 3781 | TACTACGGTG GTGGCTATGG CTCTACCCAG GCCACCTTCA TGGTGTTCCA AGCCTTGGCT | |
| 3841 | CAATACCAAA AGGACGCCCC TGACCACCAG GAACTGAACC TTGATGTGTC CCTCCAACTG | |
| 3901 | CCCAGCCGCA GCTCCAAGAT CACCCACCGT ATCCACTGGG AATCTGCCAG CCTCCTGCGA | C3dg ENDS |
| 3961 | TCAGAAGAGA CCAAGGAAAA TGAGGGTTTC ACAGTCACAG CTGAAGGAAA AGGCCAAGGC | |
| 4021 | ACCTTGTCGG TGGTGACAAT GTACCATGCT AAGGCCAAAG ATCAACTCAC CTGTAATAAA | |
| 4081 | TTCGACCTCA AGGTCACCAT AAAACCAGCA CCGGAAACAG AAAAGAGGCC TCAGGATGCC | |
| 4141 | AAGAACACTA TGATCCTTGA GATCTGTACC AGGTACCGGG GAGACCAGGA TGCCACTATG | |
| 4201 | TCTATATTGG ACATATCCAT GATGACTGGC TTTGCTCCAG ACACAGATGA CCTGAAGCAG | |
| 4261 | CTGGCCAATG GTGTTGACAG ATACATCTCC AAGTATGAGC TGGACAAAGC CTTCTCCGAT | |
| 4321 | AGGAACACCC TCATCATCTA CCTGGACAAG GTCTCACACT CTGAGGATGA CTGTCTAGCT | |
| 4381 | TTCAAAGTTC ACCAATACTT TAATGTAGAG CTTATCCAGC CTGGAGCAGT CAAGGTCTAC | |
| 4441 | GCCTATTACA ACCTGGAGGA AAGCTGTACC CGGTTCTACC ATCCGGAAAA GGAGGATGGA | |
| 4501 | AAGCTGAACA AGCTCTGCCG TGATGAACTG TGCCGCTGTG CTGAGGAGAA TTGCTTCATA | |
| 4561 | CAAAAGTCGG ATGACAAGGT CACCCTGGAA GAACGGCTGG ACAAGGCCTG TGAGCCAGGA | |
| 4621 | GTGGACTATG TGTACAAGAC CCGACTGGTC AAGGTTCAGC TGTCCAATGA CTTTGACGAG | |
| 4681 | TACATCATGG CCATTGAGCA GACCATCAAG TCAGGCTCGG ATGAGGTGCA GGTTGGACAG | |
| 4741 | CAGCGCACGT TCATCAGCCC CATCAAGTGC AGAGAAGCCC TGAAGCTGGA GGAGAAGAAA | |
| 4801 | CACTACCTCA TGTGGGGTCT CTCCTCCGAT TTCTGGGGAG AGAAGCCCAA CCTCAGCTAC | |
| 4861 | ATCATCGGGA AGGACACTTG GGTGGAGCAC TGGCCTGAGG AGGACGAATG CCAAGACGAA | |
| 4921 | GAGAACCAGA AACAATGCCA GGACCTCGGC GCCTTCACCG AGAGCATGGT TGTCTTTGGG | |
| 4981 | TGCCCCAACT GA | |

TABLE 4

Similar to Complement C3: [Spot 1511]
Full length AA Sequence: Accession # 55648063:
LC/MS/MS identified peptides scanning the highlighted red

| | | |
|---|---|---|
| 1 | MGPTSGPSLL LLLLTHLPLA LGSPMYSIIT PNILRLESEE TVVLEAHDAQ GDVPVTVIVH | |
| 61 | DFPGKKLVLS SEKTVLTPAT NHMGNVTFMI PANREFKSEK GRNKFVTVQA TFGAQVVEKV | |
| 121 | VLVSLQSGYL FIQTDKTIYT PGSTVLYRIF TVNHKLLPVG RTVMVNIEVP ARGGPRGSRG | |
| 181 | TGLGEAKRSR ETEKDTPEGV QFLYGKKVEG TAFVIFGIQD GEQRISLPES LKRIPIEDGL | |
| 241 | GEVVLSRKVL LEGVHNPRAE DLVGKSLYVS VTVILHSGSD MVQAERSGIP IVTSPYQIHF | |
| 301 | TKTPKYFKPG MPFDLMVFVT NPDGSPAYRV PVAVQGEDTV QSLTQGDGVA KLSINTHPSQ | |
| 361 | KPLSITVRTK KQELSEAEQA TSTMQALPYS TVGNSNNYLH LSVPRTELRP GETLNVNFLL | |
| 421 | RMDRAHEAKI RYYTYLIMNK GRLLKAGRQV REPGQDLVVL PLSITTDFIP SFRLVAYYTL | |
| 481 | IGASGQREVV ADSVWVDVKD SCVGSLAGQS GQSEDRQPVP GQQMTLKIEG DHGARVVLVA | |
| 541 | VDKGVFVLNK KNKLTQSKIW DVVEKADIGC TPGSGKDYAG VFSDAGLTFT SSSGQQTAQR | |
| 601 | AELQCPQPAA RRRRSVLLTE KRMDKVGKYP KELRKCCEDG MRENPMRFSC QRRTRFISLG | |
| 661 | EACKKVFLDC CNYITELRRQ HARAGHLGLG RSDLDEDIIA EENIVSRSEF PESWLWNVED | |
| 721 | LKEPPKNGIS TKLMNIFLKD SITTWEILAV SMSDKKGERG CWLVPGRESA SHIRQTRVSG | |
| 781 | SGGRGSGGAR GLVACCTHTC PDPFSPWQVR VELLHNPAFC SLATTKRRHQ QTVTIPPKSS | |
| 841 | LSVPYVIVPL KTGLQEVEVK AAVYHHFISD GVRKSLKVVP EGIRMNKTVA VRTLDPERLG | |
| 901 | REGVQKEDIP PADLSDQVPD TESETRILLQ GTPVAQMTED AVDAERLKHL IVTPSGCGEQ | Complement C3dg fragment. |
| 961 | NMIGMTPTVI AVHYLDETEQ WEKFGLEKRQ GALELIKKGY TQQLAFRQPS SAFAAFVKRA | |
| 1021 | PSTWLTAYVV KVFSLAVNLI AIDSQVLCGA VKWLILEKQK PDGVFQEDAP VIHQEMIGGL | |
| 1081 | RNNNEKDMAL TAFVLISLQE AKDICEEQVN SLPGSITKAG DFLEANYMNL QRSYTVAIAG | |
| 1141 | YALAQMGRLK GPLLNKFLTT AKDKNRWEDP GKQLYNVEAT SYALLALLQL KDFDFVPPVV | |
| 1201 | RWLNEQRYYG GGYGSTQASG PTAPRHMHPC LLRLPTGLLE KTLRPSEAVL HSHEPV | |

TABLE 5

Note: Similar to C3 (Sim2C3) is identical in to the C3dg domain to that
of Complement C3,

| | | |
|---|---|---|
| C3 | 954 | REGV |
| Sim203, | 901 | REGV |
| | | **** |
| C3, | 957 | QKEDIPPADLSDQVPDTESETRILLQGTPVAQMTEDAVDAERLKHLIVTPSGCGEQNMIG |
| Sim2C3, | 905 | QKEDIPPADLSDQVPDTESETRILLQGTPVAQMTEDAVDAERLKHLIVTPSGCGEQNMIG |
| | | ************************************************************ |
| C3, | 1017 | MTPTVIAVHYLDETEQWEKFGLEKRQGALELIKKGYTQQLAFRQPSSAFAAFVKRAPSTW |
| Sim2C3, | 965 | MTPTVIAVHYLDETEQWEKFGLEKRQGALELIKKGYTQQLAFRQPSSAFAAFVKRAPSTW |
| | | ************************************************************ |
| C3, | 1077 | LTAYVVKVFSLAVNLIAIDSQVLCGAVKWLILEKQKPDGVFQEDAPVIMQEMIGGLRNNN |
| Sim2C3, | 1025 | LTAYVVKVFSLAVNLIAIDSQVLCGAVKWLILEKQKPDGVFQEDAPVIHQEMIGGLRNNN |
| | | ************************************************************ |
| C3, | 1137 | EKDMALTAFVLISLQEAKDICEEQVNSLPGSITKAGDFLEANYMNLQRSYTVAIAGYALA |
| Sim2C3, | 1085 | EKDMALTAFVLISLQEAKDICEEQVNSLPGSITKAGDFLEANYMNLQRSYTVAIAGYALA |
| | | ************************************************************ |
| C3, | 1197 | QMGRLKGPLLNKFLTTAKDKNRWEDPGKQLYNVEATSYALLALLQLKDFDFVPPVVRWLN |
| Sim2C3, | 1145 | QMGRLKGPLLNKFLTTAKDKNRWEDPGKQLYNVEATSYALLALLQLKDFDFVPPVVRWLN |
| | | ************************************************************ |

TABLE 6
Comparison of serum levels of biomarkers of Complement C3, Complement
Factors H and Bb, and Serum Amyloid Protein (SAP) between patients
with ALS and Parkinson's disease, normal and disease controls.

| | | Average % of Normal | | | | | | |
|---|---|---|---|---|---|---|---|---|
| | | Serum Concentration PPM | | | | | Single Variable | |
| | | (n = 162 = Adult + Geriatric Normal) | | | | | Linear Discriminant | |
| | | ALS | | | | | Analysis of ALS vs. PD | |
| Protein | | fALS | sALS | ALS Like | PD | PD Like | Sensitivity | Specificity |
| Biomarker | Spot # | (n = 22) | (n = 164) | (n = 32) | (n = 29) | (n = 13) | (PD %) | (ALS %) |
| C3c₁ | 7310 | 257 | 379 | 411 | 729 | 314 | 66 | 79 |
| C3c₂ₐ | 9311 | 156 | 79 | 117 | 208 | 169 | 48 | 82 |
| C3c_{2b} | 9312 | 68 | 73 | 189 | 220 | 225 | 48 | 90 |
| C3dg | 1511 | 228 | 266 | 395 | 550 | 287 | 69 | 78 |
| Factor H | 4411 | 142 | 137 | ND* | 331 | ND | 48 | 79 |
| Factor Bb | 7616 | 92 | 77 | ND | 140 | ND | 59 | 78 |
| SAP | 3209 | 81 | 98 | ND | 68 | ND | 76 | 48 |

| | |
|---|---|
| 83 | 92 |

*ND: not determined

TABLE 7
Multivariate Biostatistics of the PD Optimal Biomarkers
Linear Discriminant Function
Single Variable Analysis
Training Set

| Biomarker | Sensitivity | Specificity |
|---|---|---|
| 1511 | 95% | 72% |
| 4325 | 67% | 69% |
| 3209 | 60% | 79% |
| 3307 | 54% | 97% |
| 4402 | 86% | 76% |
| 4411 | 81% | 52% |
| 2502 | 62% | 76% |
| 3314 | 74% | 90% |
| 1308 | 67% | 86% |
| 6315 | 90% | 55% |
| 5319 | 59% | 86% |
| 6519 | 52% | 76% |
| 5123 | 48% | 83% |
| Cumulative 13 | 86% | 99% |

TABLE 8
Validation of PD Blood Serum Biomarkers and Test
Parkinson's Disease Blood Serum Test -
13 and 34 Biomarkers Multivariate Biostatistics
Linear Discriminant Function

| | | 13 | 34 | Classi- |
|---|---|---|---|---|
| Total | | Biomarkers | Biomarkers | fication |
| | Training Set | Sensitivity | Sensitivity | |
| 29 | PD | 86% | 100% | PD |
| | | Specificity | Specificity | |
| 104 | Geriatric Normal | 99% | 100% | Normal |
| | Test Sets | Specificity | Specificity | |
| 108 | Moderate AD | 97% | 98% | Not PD |
| 121 | PD Like | 92% | 91% | ″ |
| | (incl. Mod AD) | | | |
| 58 | Adult Normal | 79% | 97% | Normal |

TABLE 9
Table VI
ALS Blood Serum Test Discriminant Biostatistical Analysis*

Classification

| | | | | |
|---|---|---|---|---|
| Diagnosis | ALS | ALS -like | Total | Performance |

Linear Discriminant Analysis

| | | | | |
|---|---|---|---|---|
| | | | | Sensitivity |
| ALS -like | 11 | 24 | 35 | 69% |
| | | | | Specificity |
| ALS | 128 | 17 | 145 | 88% |

Quadratic Discriminant Analysis

| | | | | |
|---|---|---|---|---|
| | | | | Sensitivity |
| ALS -like | 0 | 35 | 35 | 100% |
| | | | | Specificity |
| ALS | 145 | 0 | 145 | 100% |

*All 34 Biomarkers Used

What is claimed is:

1. An assay for selecting appropriate biomarkers useful in diagnosis of Amyotrophic Lateral Sclerosis (ALS), and ALS-Like disorders, comprising:
a) collecting serum samples from patients with ALS;
b) collecting serum samples from patients with an ALS-Like disorder;
c) collecting serum samples from patients with Parkinson's disease (PD);
d) collecting serum samples from patients with a PD-Like disorder;
e) collecting serum samples from patients with Alzheimer's disease (AD);
f) collecting serum samples from patients with an AD-Like disorder;
g) collecting serum samples from normal control individuals;
h) performing a two-dimensional gel electrophoretic analysis of the serum sample;
i) staining the two-dimensional gel;
j) quantitating a protein concentration in a plurality of protein spots on the two-dimensional gel; and
k) performing a statistical analysis on the quantities of the proteins in the protein spots to select a biomarker spot to distinguish between patient with ALS from patients with the ALS-Like disorder and from normal individuals.

2. An assay for selecting appropriate biomarkers useful in diagnosis of Parkinson's disease (PD), and PD-Like disorders, comprising:
a) collecting serum samples from patients with PD;
b) collecting serum samples from patients with a PD-Like disorder;
c) collecting serum samples from patients with ALS;
d) collecting serum samples from patients with an ALS-Like disorder;
e) collecting serum samples from patients with Alzheimer's disease (AD);
d) collecting serum samples from patients with an AD-Like disorder;
e) collecting serum samples from normal control individuals;
f) performing a two-dimensional gel electrophoretic analysis of the serum sample;
g) staining the two-dimensional gel;
h) quantitating a protein concentration in a plurality of protein spots on the two-dimensional gel; and
i) performing a statistical analysis on the quantities of the proteins in the protein spots to select a biomarker spot to distinguish between patients with PD from patients with the PD-Like disorder and from normal individuals.

3. An assay for diagnosis of Amyotrophic Lateral Sclerosis (ALS), and ALS-Like disorders, comprising:
a) collecting a serum sample from a patient;
b) performing a two-dimensional (2D) gel electrophoretic analysis of the serum sample;
c) staining the 2D gel pattern;
d) quantitating a set of preselected protein spots; and
e) performing a statistical analysis on the quantity of the selected spots to determine the Likelihood of the patient having ALS as opposed to an ALS-Like condition.

4. The method of claim 3, wherein the set of preselected protein spots includes one or more of the following:
a) Spot 7310 Complement C3c₁ 32.0 KD/pI 7.3
b) Spot 9311 Complement C3c₂ₐ 32.0 KD/pI 7.6
c) Spot 9312 Complement C3c_{2b} 31.2 KD/pI 7.5
d) Spot 1511 Complement C3dg 38.2 KD/pI 5.1
e) Spot 4411 Complement Factor H, short splice form 39.0 KD/pI 6.3
f) Spot 7616 Complement Factor Bb 62.0 KD/pI 7.5
g) Spot 1416 Complement Factor I 38.2 KD/pI 5.1
h) Spot 7304 Complement C4bgamma 34.0 KD/pI 7.3
i) Spot 3307 Transthyretin “dimmer” 38.0 KD/pI 5.9
j) Spot 3209 Pre-serum Amyloid Protein 29.9 KD/pI 5.4
k) Spot 3314 Apolipoprotein E3 35.0 KD/pI 6.2
l) Spot 6315 Apolipoprotein L1 35.7 KD/pI 5.9
m) Spot 2502 Apolipoprotein A-IV 40.9 KD/5.2
n) Spot 7606 Apolipoprotein H (Beta-2-glycoprotein 1) 48.1 KD/pI 6.0
o) Spot 1406 Clusterin isoform 139.0 KD/pI 5.1
p) Spot 1506 Apolipoprotein J precursor (Clusterin) 38.4 KD/pI 5.1
q) Spot 5315 Similar to Albumin 33.4 KD/pI 5.8
r) Spot 2511 Albumin protein 39.6 KD/pI 5.4
s) Spot 3417 Albumin protein (PRO2675) 35.8 KD/pI 5.5
t) Spot 4325 Albumin protein (PRO2044) 35.8 KD/pI 5.6
u) Spot 5514 Mutant Albumin 43.8 KD/pI 5.8
v) Spot 4517 Albumin protein 49.1 KD/pI 5.7
w) Spot 1514 Haptoglobin HP1 40.6 KD/pI 5.2
x) Spot 2401 Haptoglobin HP1 39.9 KD/pI 5.3
y) Spot 2407 Haptoglobin HP1 39.5 KD/pI 5.3
z) Spot 3409 Haptoglobin HP1 37.3 KD/pI 5.4
aa) Spot 4420 Haptoglobin HP1 36.8 KD/pI 5.6
bb) Spot 4402 Haptoglobin Like (Haptoglobin related protein) 36.4 KD/pI 5.6
cc) Spot 5123 Haptoglobin HP2a 19.0 KD/pI 6.7
dd) Spot 1308 Alpha-1-microglobulin 33.2 KD/pI 5.2
ee) Spot 6519 Hemopexin 42.5 KD/pI 6.0
ff) Spot 5319 Ig Kappa Chain C region 31.8 KD/pI 5.7
gg) Spot 2307 Inter-alpha-trypsin inhibitor heavy chain H4 35 KD protein PRO1851 37.0 KD/pI 5.5
hh) Spot 4130 not yet identified 26.4 KD/pI 5.7

5. An assay for diagnosis of Parkinson's disease (PD), and PD-Like disorders, comprising:
a) collecting a serum sample from a patient;
b) performing a two-dimensional (2D) gel electrophoretic analysis of the serum sample;
c) staining the 2D gel pattern;
d) quantitating a set of preselected protein spots; and
e) performing a statistical analysis on the quantity of the selected spots to determine the Likelihood of the patient having PD as opposed to a PD-Like condition.

6. The method of claim 5, wherein the set of preselected protein spots includes one or more of the following:
a) Spot 7310 Complement C3c₁ 32.0 KD/pI 7.3
b) Spot 9311 Complement C3c₂ₐ 32.0 KD/pI 7.6
c) Spot 9312 Complement C3c_{2b} 31.2 KD/pI 7.5
d) Spot 1511 Complement C3dg 38.2 KD/pI 5.1
e) Spot 4411 Complement Factor H, short splice form 39.0 KD/pI 6.3
f) Spot 7616 Complement Factor Bb 62.0 KD/pI 7.5
g) Spot 1416 Complement Factor I 38.2 KD/pI 5.1
h) Spot 7304 Complement C4bgamma 34.0 KD/pI 7.3
i) Spot 3307 Transthyretin “dimmer” 38.0 KD/pI 5.9
j) Spot 3209 Pre-serum Amyloid Protein 29.9 KD/pI 5.4
k) Spot 3314 Apolipoprotein E3 35.0 KD/pI 6.2
l) Spot 6315 Apolipoprotein L1 35.7 KD/pI 5.9
m) Spot 2502 Apolipoprotein A-IV 40.9 KD/5.2
n) Spot 7606 Apolipoprotein H (Beta-2-glycoprotein 1) 48.1 KD/pI 6.0
o) Spot 1406 Clusterin isoform 139.0 KD/pI 5.1
p) Spot 1506 Apolipoprotein J precursor (Clusterin) 38.4 KD/pI 5.1
q) Spot 5315 Similar to Albumin 33.4 KD/pI 5.8
r) Spot 2511 Albumin protein 39.6 KD/pI5.4
s) Spot 3417 Albumin protein (PRO2675) 35.8 KD/pI 5.5
t) Spot 4325 Albumin protein (PRO2044) 35.8 KD/pI 5.6
u) Spot 5514 Mutant Albumin 43.8 KD/pI 5.8
v) Spot 4517 Albumin protein 49.1 KD/pI 5.7
w) Spot 1514 Haptoglobin HP1 40.6 KD/pI 5.2
x) Spot 2401 Haptoglobin HP1 39.9 KD/pI 5.3
y) Spot 2407 Haptoglobin HP1 39.5 KD/pI 5.3
z) Spot 3409 Haptoglobin HP1 37.3 KD/pI 5.4
aa) Spot 4420 Haptoglobin HP1 36.8 KD/pI 5.6
bb) Spot 4402 Haptoglobin Like (Haptoglobin related protein) 36.4 KD/pI 5.6
cc) Spot 5123 Haptoglobin HP2a 19.0 KD/pI 6.7
dd) Spot 1308 Alpha-1-microglobulin 33.2 KD/pI 5.2
ee) Spot 6519 Hemopexin 42.5 KD/pI 6.0
ff) Spot 5319 Ig Kappa Chain C region 31.8 KD/pI 5.7
gg) Spot 2307 Inter-alpha-trypsin inhibitor heavy chain H4 35 KD protein PRO1851 37.0 KD/pI 5.5
hh) Spot 4130 not yet identified 26.4 KD/pI 5.7

7. An assay for determining the burden of disease, therapeutic targets, and monitoring of response to treatment of patients with Amyotrophic Lateral Sclerosis (ALS), comprised of:
a) collecting a serum sample from a patient;
b) performing a two-dimensional (2D) gel electrophoretic analysis of the serum sample;
c) staining the 2D gel pattern;
a) quantitating a set of preselected protein spots; and
b) performing a statistical analysis on the quantity of the selected spots to determine the magnitude of active inflammatory and immune-inflammatory neurodegeneration, oxidative stress, and inclusion body formation in the patient.

8. The method of claim 7, wherein the set of preselected protein spots includes one or more of the following:
a) Spot 7310 Complement C3c₁ 32.0 KD/pI 7.3
b) Spot 9311 Complement C3c₂ₐ 32.0 KD/pI 7.6
c) Spot 9312 Complement C3c_{2b} 31.2 KD/pI 7.5
d) Spot 1511 Complement C3dg 38.2 KD/pI 5.1
e) Spot 4411 Complement Factor H, short splice form 39.0 KD/pI 6.3
f) Spot 7616 Complement Factor Bb 62.0 KD/pI 7.5
g) Spot 1416 Complement Factor I 38.2 KD/pI 5.1
h) Spot 7304 Complement C4bgamma 34.0 KD/pI 7.3
i) Spot 3307 Transthyretin “dimmer” 38.0 KD/pI 5.9
j) Spot 3209 Pre-serum Amyloid Protein 29.9 KD/pI 5.4
k) Spot 3314 Apolipoprotein E3 35.0 KD/pI 6.2
l) Spot 6315 Apolipoprotein L1 35.7 KD/pI 5.9
m) Spot 2502 Apolipoprotein A-IV 40.9 KD/5.2
n) Spot 7606 Apolipoprotein H (Beta-2-glycoprotein 1) 48.1 KD/pI 6.0
o) Spot 1406 Clusterin isoform 1 39.0 KD/pI 5.1
p) Spot 1506 Apolipoprotein J precursor (Clusterin) 38.4 KD/pI 5.1
q) Spot 5315 Similar to Albumin 33.4 KD/pI 5.8
r) Spot 2511 Albumin protein 39.6 KD/pI 5.4
s) Spot 3417 Albumin protein (PRO2675) 35.8 KD/pI 5.5
t) Spot 4325 Albumin protein (PRO2044) 35.8 KD/pI 5.6
u) Spot 5514 Mutant Albumin 43.8 KD/pI 5.8
v) Spot 4517 Albumin protein 49.1 KD/pI 5.7
w) Spot 1514 Haptoglobin HP1 40.6 KD/pI 5.2
x) Spot 2401 Haptoglobin HP1 39.9 KD/pI 5.3
y) Spot 2407 Haptoglobin HP1 39.5 KD/pI 5.3
z) Spot 3409 Haptoglobin HP1 37.3 KD/pI 5.4
aa) Spot 4420 Haptoglobin HP1 36.8 KD/pI 5.6
bb) Spot 4402 Haptoglobin Like (Haptoglobin related protein) 36.4 KD/pI 5.6
cc) Spot 5123 Haptoglobin HP2a 19.0 KD/pI 6.7
dd) Spot 1308 Alpha-1-microglobulin 33.2 KD/pI 5.2
ee) Spot 6519 Hemopexin 42.5 KD/pI 6.0
ff) Spot 5319 Ig Kappa Chain C region 31.8 KD/pI 5.7
gg) Spot 2307 Inter-alpha-trypsin inhibitor heavy chain H4 35 KD protein PRO1851 37.0 KD/pI 5.5
hh) Spot 4130 not yet identified 26.4 KD/pI 5.7

9. An assay for determining the burden of disease, therapeutic targets, and monitoring of response to treatment of patients with Parkinson's disease (PD), comprised of:
a) collecting a serum sample from a patient;
b) performing a two-dimensional (2D) gel electrophoretic analysis of the serum sample;
c) staining the 2D gel pattern;
c) quantitating a set of preselected protein spots; and
d) performing a statistical analysis on the quantity of the selected spots to determine the magnitude of active inflammatory and immune-inflammatory neurodegeneration, oxidative stress, and inclusion body formation in the patient.

10. The method of claim 9, wherein the set of preselected protein spots includes one or more of the following:
a) Spot 7310 Complement C3c₁
b) Spot 9311 Complement C3c₂ₐ
c) Spot 9312 Complement C3c_{2b}
d) Spot 1511 Complement C3dg
e) Spot 4411 Complement Factor H, short splice form
f) Spot 7616 Complement Factor Bb
g) Spot 1416 Complement Factor I
h) Spot 7304 Complement C4bgamma
i) Spot 3307 Transthyretin dimmer
j) Spot 3209 Pre-serum Amyloid Protein
k) Spot 3314 Apolipoprotein E3
l) Spot 6315 Apolipoprotein L1
m) Spot 2502 Apolipoprotein A-IV
n) Spot 7606 Apolipoprotein H (Beta-2-glycoprotein 1)
o) Spot 5315 Similar to Albumin
p) Spot 2511 Albumin protein 40 KD/pI5.4
q) Spot 3417 Albumin protein PRO2675
r) Spot 4325 Albumin protein PRO2044
s) Spot 5514 Mutant Albumin 44 KD/pI 5.8
t) Spot 4517 Albumin protein 49 KD/pI 5.7
u) Spot 1514 Haptoglobin HP1 41 KD/pI 5.2
v) Spot 2401 Haptoglobin HP1 40 KD/pI 5.3
w) Spot 2407 Haptoglobin HP1 39.5 KD/pI 5.3
x) Spot 3409 Haptoglobin HP1 37.3 KD/pI 5.4
y) Spot 4420 Haptoglobin HP1 37 KD/pI 5.6
z) Spot 4402 Haptoglobin Like (Haptoglobin related protein)
aa) Spot 5123 Haptoglobin HP2a 19 KD/pI 6.7
bb) Spot 1308 Alpha-1-microglobulin
cc) Spot 6519 Hemopexin
dd) Spot 5319 Ig Kappa Chain C region
ee) Spot 2307 Inter-alpha-trypsin inhibitor heavy chain H4 35 KD protein PRO1851
ff) Spot 1406 Clusterin isoform 1
gg) Spot 4130 not yet identified 26.4 KD/pI 5.7
hh) Spot 1506 Apolipoprotein J precursor (Clusterin) 38.4 KD/pI 5.1


SEQUENCE LISTING (7 sequences)

SEQ ID NO: 1 - protein, 1663 aa, Homo sapiens
MGPTSGPSLLLLLLTHLPLALGSPMYSIITPNILRLESEETMVLEAHDAQGDVPVTVTVHDFPGKKLVLSSEKTVLTPATNHMGNVTFTIPANREFKSEKGRNKFVTVQATFGTQVVEKVVLVSLQSGYLFIQTDKTIYTPGSTVLYRIFTVNHKLLPVGRTVMVNIENPEGIPVKQDSLSSQNQLGVLPLSWDIPELVNMGQWKIRAYYENSPQQVFSTEFEVKEYVLPSFEVIVEPTEKFYYIYNEKGLEVTITARFLYGKKVEGTAFVIFGIQDGEQRISLPESLKRIPIEDGSGEVVLSRKVLLDGVQNPRAEDLVGKSLYVSATVILHSGSDMVQAERSGIPIVTSPYQIHFTKTPKYFKPGMPFDLMVFVTNPDGSPAYRVPVAVQGEDTVQSLTQGDGVAKLSINTHPSQKPLSITVRTKKQELSEAEQATRTMQALPYSTVGNSNNYLHLSVLRTELRPGETLNVNFLLRMDRAHEAKIRYYTYLIMNKGRLLKAGRQVREPGQDLVVLPLSITTDFIPSFRLVAYYTLIGASGQREVVADSVWVDVKDSCVGSLVVKSGQSEDRQPVPGQQMTLKIEGDHGARVVLVAVDKGVFVLNKKNKLTQSKIWDVVEKADIGCTPGSGKDYAGVFSDAGLTFTSSSGQQTAQRAELQCPQPAARRRRSVQLTEKRMDKVGKYPKELRKCCEDGMRENPMRFSCQRRTRFISLGEACKKVFLDCCNYITELRRQHARASHLGLARSNLDEDIIAEENIVSRSEFPESWLWNVEDLKEPPKNGISTKLMNIFLKDSITTWEILAVSMSDKKGICVADPFEVTVMQDFFIDLRLPYSVVRNEQVEIRAVLYNYRQNQELKVRVELLHNPAFCSLATTKRRHQQTVTIPPKSSLSVPYVIVPLKTGLQEVEVKAAVYHHFISDGVRKSLKVVPEGIRMNKTVAVRTLDPERLGREGVQKEDIPPADLSDQVPDTESETRILLQGTPVAQMTEDAVDAERLKHLIVTPSGCGEQNMIGMTPTVIAVHYLDETEQWEKFGLEKRQGALELIKKGYTQQLAFRQPSSAFAAFVKRAPSTWLTAYVVKVFSLAVNLIAIDSQVLCGAVKWLILEKQKPDGVFQEDAPVIHQEMIGGLRNNNEKDMALTAFVLISLQEAKDICEEQVNSLPGSITKAGDFLEANYMNLQRSYTVAIAGYALAQMGRLKGPLLNKFLTTAKDKNRWEDPGKQLYNVEATSYALLALLQLKDFDFVPPVVRWLNEQRYYGGGYGSTQATFMVFQALAQYQKDAPDHQELNLDVSLQLPSRSSKITHRIHWESASLLRSEETKENEGFTVTAEGKGQGTLSVVTMYHAKAKDQLTCNKFDLKVTIKPAPETEKRPQDAKNTMILEICTRYRGDQDATMSILDISMMTGFAPDTDDLKQLANGVDRYISKYELDKAFSDRNTLIIYLDKVSHSEDDCLAFKVHQYFNVELIQPGAVKVYAYYNLEESCTRFYHPEKEDGKLNKLCRDELCRCAEENCFIQKSDDKVTLEERLDKACEPGVDYVYKTRLVKVQLSNDFDEYIMAIEQTIKSGSDEVQVGQQRTFISPIKCREALKLEEKKHYLMWGLSSDFWGEKPNLSYIIGKDTWVEHWPEEDECQDEENQKQCQDLGAFTESMVVFGCPN

SEQ ID NO: 2 - protein, 203 aa, Homo sapiens
SNLDEDIIAEENIVSRSEFPESWLWNVEDLKEPPKNGISTKLMNIFLKDSITTWEILAVSMSDKKGICVADPFEVTVMQDFFIDLRLPYSVVRNEQVEIRAVLYNYRQNQELKVRVELLHNPAFCSLATTKRRHQQTVTIPPKSSLSVPYVIVPLKTGLQEVEVKAAVYHHFISDGVRKSLKVVPEGIRMNKTVAVRTLDPER

SEQ ID NO: 3 - protein, 203 aa, Homo sapiens; identical to SEQ ID NO: 2

SEQ ID NO: 4 - protein, 197 aa, Homo sapiens
SNLDEDIIAEENIVSRSEFPESWLWNVEDLKEPPKNGISTKLMNIFLKDSITTWEILAVSMSDKKGICVADPFEVTVMQDFFIDLRLPYSVVRNEQVEIRAVLYNYRQNQELKVRVELLHNPAFCSLATTKRRHQQTVTIPPKSSLSVPYVIVPLKTGLQEVEVKAAVYHHFISDGVRKSLKVVPEGIRMNKTVAVR

SEQ ID NO: 5 - protein, 349 aa, Homo sapiens
EGVQKEDIPPADLSDQVPDTESETRILLQGTPVAQMTEDAVDAERLKHLIVTPSGCGEQNMIGMTPTVIAVHYLDETEQWEKFGLEKRQGALELIKKGYTQQLAFRQPSSAFAAFVKRAPSTWLTAYVVKVFSLAVNLIAIDSQVLCGAVKWLILEKQKPDGVFQEDAPVIHQEMIGGLRNNNEKDMALTAFVLISLQEAKDICEEQVNSLPGSITKAGDFLEANYMNLQRSYTVAIAGYALAQMGRLKGPLLNKFLTTAKDKNRWEDPGKQLYNVEATSYALLALLQLKDFDFVPPVVRWLNEQRYYGGGYGSTQATFMVFQALAQYQKDAPDHQELNLDVSLQLPSR

SEQ ID NO: 6 - DNA, 4992 bp, Homo sapiens
atgggacccacctcaggtcccagcctgctgctcctgctactaacccacctccccctggctctggggagtcccatgtactctatcatcacccccaacatcttgcggctggagagcgaggagaccatggtgctggaggcccacgacgcgcaaggggatgttccagtcactgttactgtccacgacttcccaggcaaaaaactagtgctgtccagtgagaagactgtgctgacccctgccaccaaccacatgggcaacgtcaccttcacgatcccagccaacagggagttcaagtcagaaaaggggcgcaacaagttcgtgaccgtgcaggccaccttcgggacccaagtggtggagaaggtggtgctggtcagcctgcagagcgggtacctcttcatccagacagacaagaccatctacacccctggctccacagttctctatcggatcttcaccgtcaaccacaagctgctacccgtgggccggacggtcatggtcaacattgagaacccggaaggcatcccggtcaagcaggactccttgtcttctcagaaccagcttggcgtcttgcccttgtcttgggacattccggaactcgtcaacatgggccagtggaagatccgagcctactatgaaaactcaccacagcaggtcttctccactgagtttgaggtgaaggagtacgtgctgcccagtttcgaggtcatagtggagcctacagagaaattctactacatctataacgagaagggcctggaggtcaccatcaccgccaggttcctctacgggaagaaagtggagggaactgcctttgtcatcttcgggatccaggatggcgaacagaggatttccctgcctgaatccctcaagcgcattccgattgaggatggctcgggggaggttgtgctgagccggaaggtactgctggacggggtgcagaacctccgagcagaagacctggtggggaagtctttgtacgtgtctgccaccgtcatcttgcactcaggcagtgacatggtgcaggcagagcgcagcgggatccccatcgtgacctctccctaccagatccacttcaccaagacacccaagtacttcaaaccaggaatgccctttgacctcatggtgttcgtgacgaaccctgatggctctccagcctaccgagtccccgtggcagtccagggcgaggacactgtgcagtctctaacccagggagatggcgtggccaaactcagcatcaacacacaccccagccagaagcccttgagcatcacggtgcgcacgaagaagcaggagctctcggaggcagagcaggctaccaggaccatgcaggctctgccctacagcaccgtgggcaactccaacaattacctgcatctctcagtgctacgtacagagctcagacccggggagaccctcaacgtcaacttcctcctgcgaatggaccgcgcccacgaggccaagatccgctactacacctacctgatcatgaacaagggcaggctgttgaaggcgggacgccaggtgcgagagcccggccaggacctggtggtgctgcccctgtccatcaccaccgacttcatcccttccttccgcctggtggcgtactacacgctgatcggtgccagcggccagagggaggtggtggccgactccgtgtgggtggacgtcaaggactcctgcgtgggctcgctggtggtaaaaagcggccagtcagaagaccggcagcctgtacctgggcagcagatgaccctgaagatagagggtgaccacggggcccgggtggtactggtggccgtggacaagggcgtgttcgtgctgaataagaagaacaaactgacgcagagtaagatctgggacgtggtggagaaggcagacatcggctgcaccccgggcagtgggaaggattacgccggtgtcttctccgacgcagggctgaccttcacgagcagcagtggccagcagaccgcccagagggcagaacttcagtgcccgcagccagccgcccgccgacgccgttccgtgcagctcacggagaagcgaatggacaaagtcggcaagtaccccaaggagctgcgcaagtgctgcgaggacggcatgcgggagaaccccatgaggttctcgtgccagcgccggacccgtttcatctccctgggcgaggcgtgcaagaaggtcttcctggactgctgcaactacatcacagagctgcggcggcagcacgcgcgggccagccacctgggcctggccaggagtaacctggatgaggacatcattgcagaagagaacatcgtttcccgaagtgagttcccagagagctggctgtggaacgttgaggacttgaaagagccaccgaaaaatggaatctctacgaagctcatgaatatatttttgaaagactccatcaccacgtgggagattctggctgtcagcatgtcggacaagaaagggatctgtgtggcagaccccttcgaggtcacagtaatgcaggacttcttcatcgacctgcggctaccctactctgttgttcgaaacgagcaggtggaaatccgagccgttctctacaattaccggcagaaccaagagctcaaggtgagggtggaactactccacaatccagccttctgcagcctggccaccaccaagaggcgtcaccagcagaccgtaaccatcccccccaagtcctcgttgtccgttccatatgtcatcgtgccgctaaagaccggcctgcaggaagtggaagtcaaggctgccgtctaccatcatttcatcagtgacggtgtcaggaagtccctgaaggtcgtgccggaaggaatcagaatgaacaaaactgtggctgttcgcaccctggatccagaacgcctgggccgtgaaggagtgcagaaagaggacatcccacctgcagacctcagtgaccaagtcccggacaccgagtctgagaccagaattctcctgcaagggaccccagtggcccagatgacagaggatgccgtcgacgcggaacggctgaagcacctcattgtgaccccctcgggctgcggggaacagaacatgatcggcatgacgcccacggtcatcgctgtgcattacctggatgaaacggagcagtgggagaagttcggcctagagaagcggcagggggccttggagctcatcaagaaggggtacacccagcagctggccttcagacaacccagctctgcctttgcggccttcgtgaaacgggcacccagcacctggctgaccgcctacgtggtcaaggtcttctctctggctgtcaacctcatcgccatcgactcccaagtcctctgcggggctgttaaatggctgatcctggagaagcagaagcccgacggggtcttccaggaggatgcgcccgtgatacaccaagaaatgattggtggattacggaacaacaacgagaaagacatggccctcacggcctttgttctcatctcgctgcaggaggctaaagatatttgcgaggagcaggtcaacagcctgccaggcagcatcactaaagcaggagacttccttgaagccaactacatgaacctacagagatcctacactgtggccattgctggctatgctctggcccagatgggcaggctgaaggggcctcttcttaacaaatttctgaccacagccaaagataagaaccgctgggaggaccctggtaagcagctctacaacgtggaggccacatcctatgccctcttggccctactgcagctaaaagactttgactttgtgcctcccgtcgtgcgttggctcaatgaacagagatactacggtggtggctatggctctacccaggccaccttcatggtgttccaagccttggctcaataccaaaaggacgcccctgaccaccaggaactgaaccttgatgtgtccctccaactgcccagccgcagctccaagatcacccaccgtatccactgggaatctgccagcctcctgcgatcagaagagaccaaggaaaatgagggtttcacagtcacagctgaaggaaaaggccaaggcaccttgtcggtggtgacaatgtaccatgctaaggccaaagatcaactcacctgtaataaattcgacctcaaggtcaccataaaaccagcaccggaaacagaaaagaggcctcaggatgccaagaacactatgatccttgagatctgtaccaggtaccggggagaccaggatgccactatgtctatattggacatatccatgatgactggctttgctccagacacagatgacctgaagcagctggccaatggtgttgacagatacatctccaagtatgagctggacaaagccttctccgataggaacaccctcatcatctacctggacaaggtctcacactctgaggatgactgtctagctttcaaagttcaccaatactttaatgtagagcttatccagcctggagcagtcaaggtctacgcctattacaacctggaggaaagctgtacccggttctaccatccggaaaaggaggatggaaagctgaacaagctctgccgtgatgaactgtgccgctgtgctgaggagaattgcttcatacaaaagtcggatgacaaggtcaccctggaagaacggctggacaaggcctgtgagccaggagtggactatgtgtacaagacccgactggtcaaggttcagctgtccaatgactttgacgagtacatcatggccattgagcagaccatcaagtcaggctcggatgaggtgcaggttggacagcagcgcacgttcatcagccccatcaagtgcagagaagccctgaagctggaggagaagaaacactacctcatgtggggtctctcctccgatttctggggagagaagcccaacctcagctacatcatcgggaaggacacttgggtggagcactggcctgaggaggacgaatgccaagacgaagagaaccagaaacaatgccaggacctcggcgccttcaccgagagcatggttgtctttgggtgccccaactga

SEQ ID NO: 7 - protein, 1256 aa, Homo sapiens
MGPTSGPSLLLLLLTHLPLALGSPMYSIITPNILRLESEETVVLEAHDAQGDVPVTVIVHDFPGKKLVLSSEKTVLTPATNHMGNVTFMIPANREFKSEKGRNKFVTVQATFGAQVVEKVVLVSLQSGYLFIQTDKTIYTPGSTVLYRIFTVNHKLLPVGRTVMVNIEVPARGGPRGSRGTGLGEAKRSRETEKDTPEGVQFLYGKKVEGTAFVIFGIQDGEQRISLPESLKRIPIEDGLGEVVLSRKVLLEGVHNPRAEDLVGKSLYVSVTVILHSGSDMVQAERSGIPIVTSPYQIHFTKTPKYFKPGMPFDLMVFVTNPDGSPAYRVPVAVQGEDTVQSLTQGDGVAKLSINTHPSQKPLSITVRTKKQELSEAEQATSTMQALPYSTVGNSNNYLHLSVPRTELRPGETLNVNFLLRMDRAHEAKIRYYTYLIMNKGRLLKAGRQVREPGQDLVVLPLSITTDFIPSFRLVAYYTLIGASGQREVVADSVWVDVKDSCVGSLAGQSGQSEDRQPVPGQQMTLKIEGDHGARVVLVAVDKGVFVLNKKNKLTQSKIWDVVEKADIGCTPGSGKDYAGVFSDAGLTFTSSSGQQTAQRAELQCPQPAARRRRSVLLTEKRMDKVGKYPKELRKCCEDGMRENPMRFSCQRRTRFISLGEACKKVFLDCCNYITELRRQHARAGHLGLGRSDLDEDIIAEENIVSRSEFPESWLWNVEDLKEPPKNGISTKLMNIFLKDSITTWEILAVSMSDKKGERGCWLVPGRESASHIRQTRVSGSGGRGSGGARGLVACCTHTCPDPFSPWQVRVELLHNPAFCSLATTKRRHQQTVTIPPKSSLSVPYVIVPLKTGLQEVEVKAAVYHHFISDGVRKSLKVVPEGIRMNKTVAVRTLDPERLGREGVQKEDIPPADLSDQVPDTESETRILLQGTPVAQMTEDAVDAERLKHLIVTPSGCGEQNMIGMTPTVIAVHYLDETEQWEKFGLEKRQGALELIKKGYTQQLAFRQPSSAFAAFVKRAPSTWLTAYVVKVFSLAVNLIAIDSQVLCGAVKWLILEKQKPDGVFQEDAPVIHQEMIGGLRNNNEKDMALTAFVLISLQEAKDICEEQVNSLPGSITKAGDFLEANYMNLQRSYTVAIAGYALAQMGRLKGPLLNKFLTTAKDKNRWEDPGKQLYNVEATSYALLALLQLKDFDFVPPVVRWLNEQRYYGGGYGSTQASGPTAPRHMHPCLLRLPTGLLEKTLRPSEAVLHSHEPV